(19) United States
(12) Patent Application Publication
(10) Pub. No.: US 2002/0083128 A1
(43) Pub. Date: Jun. 27, 2002

(54) Automatic remote electronic instrument connecting system and method

(76) Inventors: Jun Miyajima, Tokyo (JP); Satoshi Umezu, Tokyo (JP); Takahiro Yamaguchi, Tokyo (JP)

Correspondence Address: DELLETT AND WALTERS, 310 S.W. FOURTH AVENUE, SUITE 1101, PORTLAND, OR, 97204, US

(21) Appl. No.: 09/995,402

(22) Filed: Nov. 26, 2001

Related U.S. Application Data
(63) Continuation-in-part of application No. 09/165,267, filed on Oct. 1, 1998.

(30) Foreign Application Priority Data
Oct. 2, 1997 (JP) 9-286167

(51) Int. Cl. G06F 15/16

(52) U.S. Cl. 709/203; 709/227

(57) ABSTRACT

An automatic remote electronic instrument connecting system and method are disclosed in which server apparatuses to which electronic measuring apparatuses are connected and a client apparatus for remote-controlling these electronic measuring apparatuses are connected together via a network. A dispatcher apparatus connected to the network sets a communication path, and the server apparatus and the client apparatus execute data communication via this communication path.

### BACKGROUND OF THE INVENTION

The present invention relates to an automatic remote electronic instrument connecting system and method for using Ethernet between computers to connect electronic measuring apparatuses together in order to collect data.

The use of Ethernet between computers for data communication is applied to electronic measuring apparatuses. That is, Ethernet can be used to transmit from a computer to an electronic measuring apparatus, commands unique to the electronic measuring apparatus that cause the apparatus to perform specified operations or to transmit from the electronic measuring apparatus to the computer, data measured by the measuring apparatus.

In general, a program controlling an electronic measuring apparatus is executed by a computer to enable data communication between the computer and the measuring apparatus. In addition, the operation of the electronic measuring apparatus is controlled by the contents of various data transmitted from the computer.

To allow data communication between an electronic measuring apparatus and a computer, an ID number corresponding to each electronic measuring apparatus is required to enable the computer to identify the electronic measuring apparatus with which the computer is to communicate. When, however, the ID number of the electronic measuring apparatus is directly described in a program controlling the measuring apparatus, the electronic measuring apparatus that can be controlled using that program is fixed. For example, if an electronic measuring apparatus A is connected to a computer, the ID number of the electronic measuring apparatus A is described in a program P controlling the apparatus A so that the apparatus A is identified based on this ID number when the program P is executed. If, however, this electronic measuring apparatus A is changed to an electronic measuring apparatus A′ of the same type having a different product number, the new electronic measuring apparatus A′ cannot be controlled by executing the program P. To control the electronic measuring apparatus A′, the ID number described in the program P must be modified to an ID number corresponding to the new electronic measuring apparatus A′.

In addition, if an electronic measuring apparatus is connected to a computer using Ethernet, data can be communicated between the computer and the measuring apparatus without restrictions on the connection distance. Thus, an electronic measuring apparatus may be installed at a large distance from a computer executing a program that controls the measuring apparatus or a user may execute the program at a distance from the electronic measuring apparatus. If, however, the power to the desired electronic measuring apparatus has not been turned on, measurements cannot be executed normally by activating from the computer the program controlling the electronic measuring apparatus.

Thus, to execute data communication between a computer and an electronic measuring apparatus using Ethernet, the following two conditions must be met: (1) the power is turned on to enable the measuring apparatus, and (2) the ID number of the electronic measuring apparatus described in a program controlling data communication between the measuring apparatus and the computer matches the ID number of the electronic measuring apparatus with which the computer is to communicate.

To meet these two conditions, the program user, when executing the program that allows the computer to control the measuring apparatus, must confirm that the power to the electronic measuring apparatus has been turned on. In addition, to change the electronic measuring apparatus, modifications to the program, such as changing the ID number of the apparatus, must be made prior to execution. Thus, the user must bear a heavy burden in order to meet these two conditions.

This invention is provided in view of these points, and its object is to provide an automatic remote electronic instrument connecting system and method that can reduce the burden on the user.

### SUMMARY OF THE INVENTION

According to one preferred embodiment, an automatic remote electronic instrument connecting system comprises server apparatuses to which electronic measuring apparatuses are connected; a client apparatus for remote-controlling the electronic measuring apparatuses; and a dispatcher apparatus for setting a communication path that is used for data communication between a server apparatus and the client apparatus, wherein the server, client, and dispatcher apparatuses are connected together via a predetermined network, preferably Ethernet. The dispatcher apparatus can set a communication path so that the client apparatus can communicate data to an electronic measuring apparatus via this set communication path, thereby reducing the burden on the client apparatus and a user operating the client apparatus to execute predetermined measurements.

In addition, the client apparatus described above includes a communicable-server-apparatus query section for requesting prior to data transmission to the server apparatus, a list data on the server apparatuses and electronic measuring apparatuses connected to the network, and the dispatcher apparatus includes a communicable-server-apparatus query response section for returning the list data in response to the request. Thus, the client apparatus can determine before carrying out predetermined measurements, the presence of an electronic measuring apparatus that is actually connected to the network and that can be allowed to execute desired measuring operations and of a server apparatus including this measuring apparatus, in order to reliably and freely specify the electronic measuring apparatus and the server apparatus from a selectable range.

In addition, the client apparatus comprises a data communication request section for requesting a communication path to be established before data transmission to a server apparatus, and the dispatcher apparatus includes a data communication request processing section for checking in response to the data communication request from the data communication request section whether the electronic measuring apparatus is enabled to communicate and if so, establishing the communication path. Thus, after the data communication request section has obtained the communication path established by the data communication request processing section, the client apparatus and the electronic measuring apparatus can execute predetermined data communication via the communication path obtained, thereby eliminating the needs for an operation for confirming a power-on state for establishing the communication path.

In particular, since the dispatcher apparatus includes a server apparatus information storage section for storing information on actually connected server apparatuses, the data communication request processing section can determine based on this stored information whether a desired server apparatus is enabled to communicate, thereby reducing the burden of processing required for this determination.

In addition, since the server apparatus includes a data communication request determining section for determining whether a desired electronic measurement apparatus is enabled to communicate, the data communication request processing section can obtain the result of this determination from the data communication request determining section. As a result, this determination can be executed accurately.

### BRIEF DESCRIPTION OF THE DRAWINGS

FIG. 1 shows the entire configuration of an electronic-measuring-apparatus communication system according to one embodiment;

FIG. 2 is a flowchart showing an outline of an operational procedure by which an electronic-measuring-apparatus client apparatus obtains a communication channel;

FIG. 3 is a flowchart showing a detailed operational procedure by which an electronic-measuring-apparatus server apparatus registers its own information in an electronic-measuring-apparatus dispatcher apparatus;

FIG. 4 is a flowchart showing a detailed operational procedure by which the electronic-measuring-apparatus client apparatus obtains a list of the names of communicable electronic-measuring-apparatus server apparatuses;

FIG. 5 is a flowchart showing a detailed operational procedure from the output of a data transmission request from the electronic-measuring-apparatus client apparatus until the client apparatus obtains a communication channel;

FIG. 6 is a flowchart showing a detailed operational procedure from the output of a data transmission request from the electronic-measuring-apparatus client apparatus until the client apparatus obtains a communication channel;

FIG. 7 is a flowchart showing a detailed operational procedure from the output of a data transmission request from the electronic-measuring-apparatus client apparatus until the client apparatus obtains a communication channel;

FIG. 8 is a flowchart showing a detailed operational procedure from the output of a data transmission request from the electronic-measuring-apparatus client apparatus until the client apparatus obtains a communication channel;

FIG. 9 shows an operational procedure by which the electronic-measuring-apparatus client apparatus communicates data to the electronic-measuring-apparatus server apparatus;

FIG. 10 shows an operational procedure by which the electronic-measuring-apparatus server apparatus communicates data to the electronic-measuring-apparatus client apparatus;

FIG. 11 shows a detailed configuration of a connection switch section;

FIG. 12 is a flowchart showing an operational procedure for transmitting data via a transmission switch in the connection switch section;

FIG. 13 is a flowchart showing an operational procedure for receiving data via a reception switch in the connection switch section;

FIG. 14 shows a specific configuration of a connection method used in an environment in which a plurality of computers are connected together using 10Base-T Ethernet cables;

FIG. 15 shows a detailed configuration of the communication devices included in the electronic-measuring-apparatus server apparatus shown in FIG. 14;

FIG. 16 shows a specific configuration of a connection method used in an environment in which a plurality of computers are connected together using 10Base-5 Ethernet cables;

FIG. 17 shows a detailed configuration of the communication devices included in the electronic-measuring-apparatus server apparatus shown in FIG. 16;

FIG. 18 shows a specific configuration of a connection method used in an environment in which a plurality of computers are connected together using 10Base-2 Ethernet cables;

FIG. 19 shows a detailed configuration of the communication devices included in the electronic-measuring-apparatus server apparatus shown in FIG. 18; and

FIG. 20 shows an explaining view of a variation of the electronic-measuring-apparatus communications system using the registered information data containing the detailed information.

### DESCRIPTION OF THE PREFERRED EMBODIMENT

An electronic-measuring-apparatus communication system according to one embodiment to which an automatic remote electronic instrument connecting system and method of this invention is applied is characterized in that the system includes an electronic-measuring-apparatus dispatcher apparatus for connecting an electronic-measuring-apparatus server apparatus including an electronic measuring apparatus to Ethernet and managing this connection state, thereby enabling a client apparatus to easily confirm the power-on state of an electronic measuring apparatus and a change in system configuration. The electronic-measuring-apparatus communication system according to this embodiment is described below in detail with reference to the drawings.

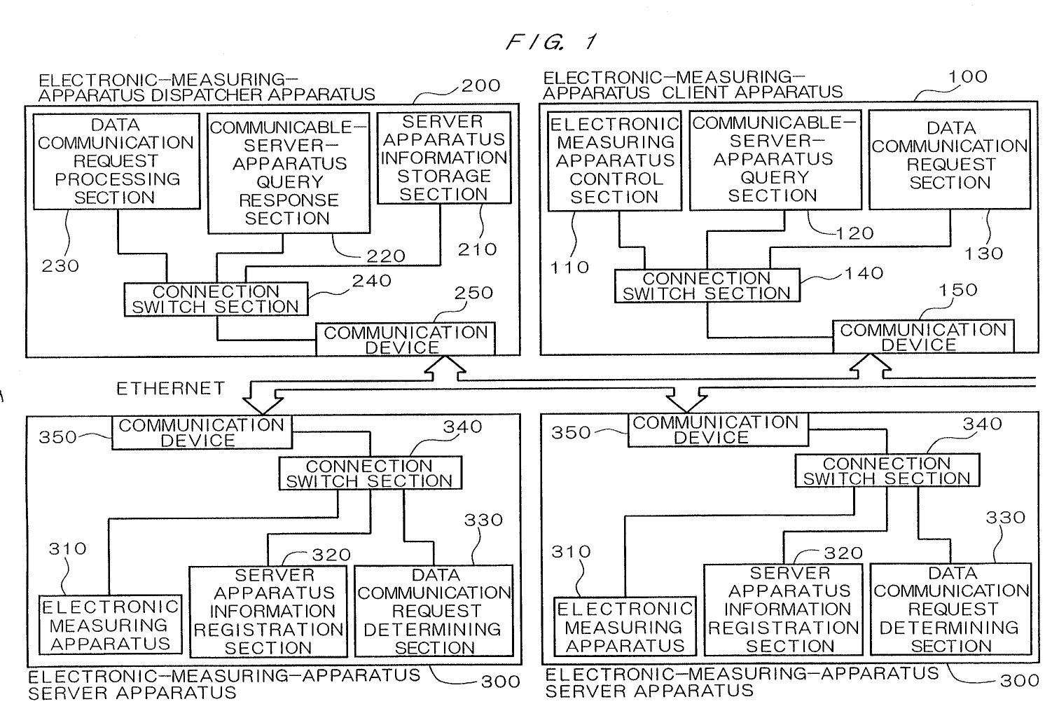

FIG. 1 shows the entire configuration of the electronic-measuring-apparatus communication system according to this embodiment. As shown in this figure, the electronic-measuring-apparatus communication system according to this embodiment comprises an electronic-measuring-apparatus client apparatus 100, an electronic-measuring-apparatus dispatcher apparatus 200, and an electronic-measuring-apparatus server apparatus 300 that are connected together via Ethernet. One or more electronic-measuring-apparatus client apparatuses 100 and electronic-measuring-apparatus server apparatuses 300 can b e connected to the network, and the electronic-measuring-apparatus communication system according to this embodiment shown in FIG. 1 shows a configuration in which one electronic-measuring-apparatus client apparatus 100 and two electronic-measuring-apparatus server apparatuses 300 are connected together.

The electronic-measuring-apparatus client apparatus 100 is composed of an electronic-measuring-apparatus control section 110, a communicable-server-apparatus query section 120, a data communication request section 130, a connection switch section 140, and communication device 150. The electronic-measuring-apparatus control section 110 creates various data that is transmitted to an electronic measuring apparatus in the electronic-measuring-apparatus server apparatus 300, and obtains various data transmitted from the electronic measuring apparatus. The communicable-server-apparatus query section 120 creates and outputs query data for a check on which electronic-measuring-apparatus server apparatuses 300 are enabled to communicate, and obtains a list data indicating the names of electronic-measuring-apparatus server apparatuses 300 enabled to communicate returned in response to the query data. The data communication request section 130 creates data that is transmitted to the electronic-measuring-apparatus dispatcher apparatus 200 and that indicates a data communication request, and obtains a communication channel as a communication path.

The electronic-measuring-apparatus dispatcher apparatus 200 operates as a communication management apparatus and is composed of a server apparatus information storage section 210, a communicable-server-apparatus query response section 220, a data communication request processing section 230, a connection switch section 240, and a communication device 250. The server apparatus information storage section 210 stores registered information that is transmitted from electronic-measuring-apparatus server apparatus 300 and that is unique to that server apparatus. The communicable-server-apparatus query response section 220 creates list data that is returned in response to a query from the electronic-measuring-apparatus client apparatus 100 and that indicates the names of electronic-measuring-apparatus server apparatuses 300 enabled to communicate. When the electronic-measuring-apparatus client apparatus 100 requests data communication, the data communication request processing section 230 checks whether there is any electronic-measuring-apparatus server apparatus 300 with which it can communicate, and if so, establishes a communication channel.

The electronic-measuring-apparatus server apparatus 300 is composed of an electronic measuring apparatus 310, a server apparatus information registration section 320, a data communication request determining section 330, a connection switch section 340, and a communication device 350. The electronic measuring apparatus 310 executes analog or digital signal processing for a predetermined measurement operation and outputs the result as digital data. Electronic measuring apparatuses of different specifications are combined together as required. When the electronic-measuring-apparatus server apparatus 300 is enabled to communicate after the power to the electronic measuring apparatus 310 has been turned on, the server apparatus information registration section 320 creates registered information unique to itself. Upon receiving a request for the establishment of a communication channel from the electronic-measuring-apparatus dispatcher apparatus 200, the data communication request determining section 330 determines whether data can be communicated via a communication channel.

The electronic-measuring-apparatus communication system according to this embodiment has this configuration and its operation is described below. First, operations are described that are performed until the electronic-measuring-apparatus client apparatus 100 obtains a communication channel to the electronic-measuring-apparatus server apparatus 300 from the electronic-measuring-apparatus dispatcher apparatus 200.

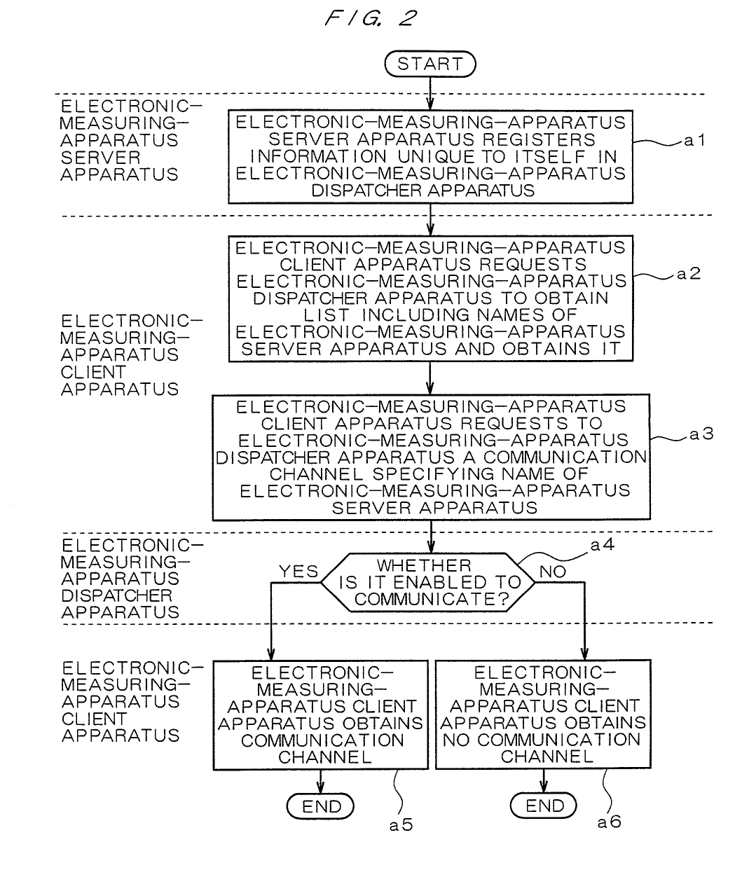

FIG. 2 is a flowchart showing an outline of an operational procedure by which the electronic-measuring-apparatus client apparatus 100 obtains a communication channel. When the power is turned on, the electronic-measuring-apparatus server apparatus 300 registers in the electronic-measuring-apparatus dispatcher apparatus 200 the information unique to the apparatus 300 including the electronic measuring apparatus 310 (specifically, the information includes the name of the electronic-measuring-apparatus server apparatus 300 and the ID number of the electronic measuring apparatus 310) (step al). In this manner, the information unique to all the electronic-measuring-apparatus server apparatuses 300 connected via Ethernet is registered.

To set a communication channel to a predetermined electronic measuring apparatus 310, the electronic-measuring-apparatus client apparatus 100 requests the electronic-measuring-apparatus dispatcher apparatus 200 to obtain the list including the names of electronic-measuring-apparatus server apparatuses 300 enabled to communicate and obtains it through the apparatus 200 (step a2). Then, to establish a communication channel to an electronic-measuring-apparatus server apparatus 300 corresponding to any of the names in the list obtained, the electronic-measuring-apparatus client apparatus 100 transmits to the electronic-measuring-apparatus dispatcher apparatus 200 a data communication request specifying the name of this electronic-measuring-apparatus server apparatus 300 (step a3). In response to the transmitted data communication request, the electronic-measuring-apparatus dispatcher apparatus 200 determines whether the specified electronic-measuring-apparatus server apparatus 300 is enabled to communicate (step a4). If so, the electronic-measuring-apparatus dispatcher apparatus 200 responds to the electronic-measuring-apparatus client apparatus 100 by indicating a communication channel to the electronic-measuring-apparatus server apparatus 300 enabled to communicate, and the electronic-measuring-apparatus client apparatus 100 obtains the indicated communication channel (step a5). Otherwise, the electronic-measuring-apparatus dispatcher apparatus 200 transmits to the electronic-measuring-apparatus client apparatus 100 predetermined data indicating that a communication channel to the electronic-measuring-apparatus server apparatus 300 cannot be established, and the electronic-measuring-apparatus client apparatus 100 determines that no communication channel has been obtained (step a6).

Thus, according to the electronic-measuring-apparatus communication system according to this embodiment, the electronic-measuring-apparatus dispatcher apparatus 200 has registered therein the list including the names of the electronic-measuring-apparatus server apparatuses 300 connected to Ethernet at that point of time and the ID numbers of the electronic measuring apparatus 310 included in these apparatuses 300. The electronic-measuring-apparatus client apparatus 100 attempting to obtain a communication channel for a predetermined measurement can obtain this list to determine what electronic-measuring-apparatus server apparatuses 300 and electronic measuring apparatus 310 are connected to the network at that point of time. Thus, even if any electronic-measuring-apparatus server apparatus 300 is added to or removed from the network or the electronic measuring apparatus 310 in any electronic-measuring-apparatus server apparatus 300 and thus its ID number are changed, the electronic-measuring-apparatus client apparatus 100 can determine the contents of such a change. In addition, due to its capability of determining beforehand the electronic-measuring-apparatus server apparatuses 300 connected to the network at that point of time, the electronic-measuring-apparatus client apparatus 100 can automatically select an actually available electronic-measuring-apparatus server apparatus 300.

In addition, the control of the electronic-measuring-apparatus server apparatuses 300 and electronic measuring apparatuses 310 and thus the management of users' data are centered on the electronic-measuring-apparatus dispatcher apparatus 200, thereby enabling such data to be maintained easily.

Instead of directly specifying the ID number of an electronic measuring apparatus 310, a data transmission request transmitted from the electronic-measuring-apparatus client apparatus 100 to request a communication channel to be set specifies the name of the corresponding electronic-measuring-apparatus server apparatus 300, so program mistakes can be reduced by setting this name so that the user can understand it easily (for example, Spectrum Analyzer).

In addition, although the use of special electronic-measuring-apparatus data communication (for example, GPIB) for connection to an electronic measuring apparatus, as in the prior art, requires a special protocol to be understood to create a control program, this embodiment uses a flexible open network for connections to communicate data to allow a general control program to be created so as to correspond to a commonly used protocol. Consequently, the number of steps required to create a program can be substantially reduced.

In addition, the use of Ethernet, which is a computer network that can be inexpensively constructed, enables the entire system to be implemented inexpensively. The data rate of Ethernet is expected to increase in the future, so the data rate between Ethernet and the electronic measuring apparatus 310 can be increased accordingly.

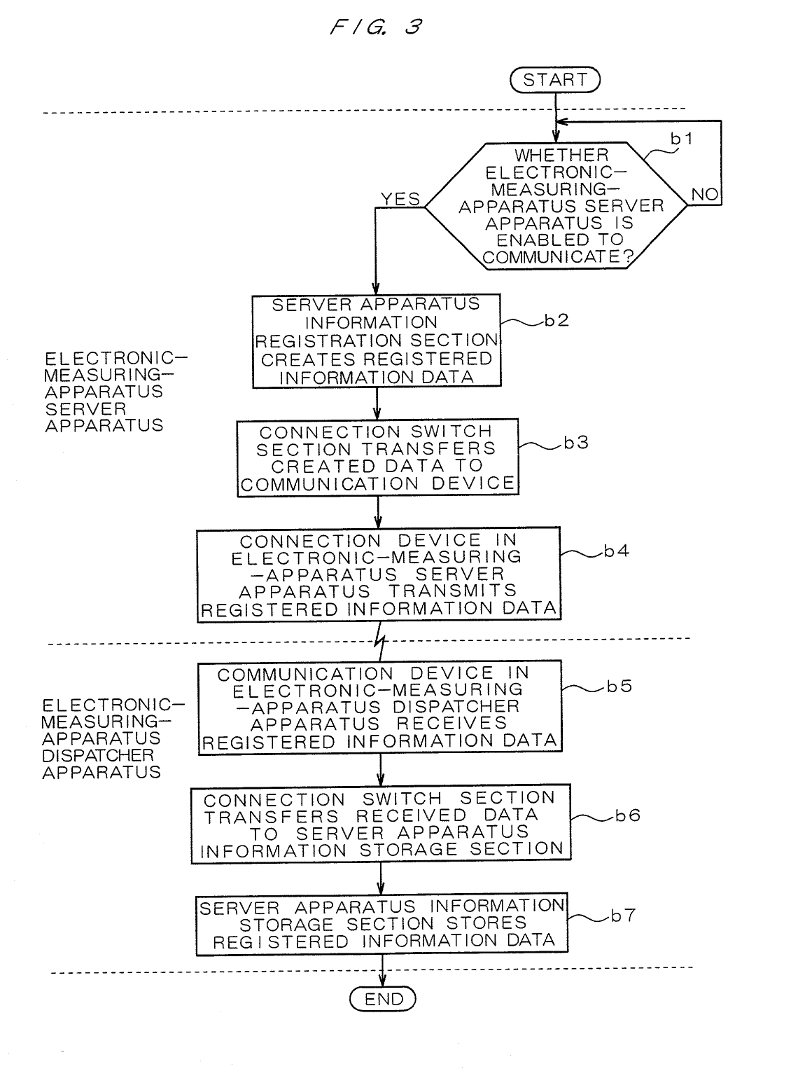

Next, operations performed until the electronic-measuring-apparatus client apparatus 100 obtains a communication channel are described in detail. FIG. 3 is a flowchart showing a detailed operational procedure by which the electronic-measuring-apparatus server apparatus 300 registers its own information in the electronic-measuring-apparatus dispatcher apparatus 200 in step al. First, the server apparatus information registration section 320 in the electronic-measuring-apparatus server apparatus 300 determines whether the electronic measuring apparatus 310 has been powered on and enabled to communicate data (step b1), and if so, creates registered information data including its own name and the ID number of the electronic measuring apparatus 310 (step b2). Once the registered information data has been created, the connection switch section 340 connects the server apparatus information registration section 320 and the communication device 350 together, and the server apparatus information registration section 320 then transfers the created registered information data to the communication device 350 (step b3), which then transmits this data to Ethernet (step b4).

When the registered information data is transmitted to Ethernet from the communication device 350 in the electronic-measuring-apparatus server apparatus 300 in this manner, the communication device 250 in the electronic-measuring-apparatus dispatcher apparatus 200 receives this data (step b5), which is then transferred by the connection switch section 240 to the server apparatus information storage section 210 (step b6). The server apparatus information storage section 210 stores the transferred registered information data (step b7), and the series of operations for registering the registered information data finishes.

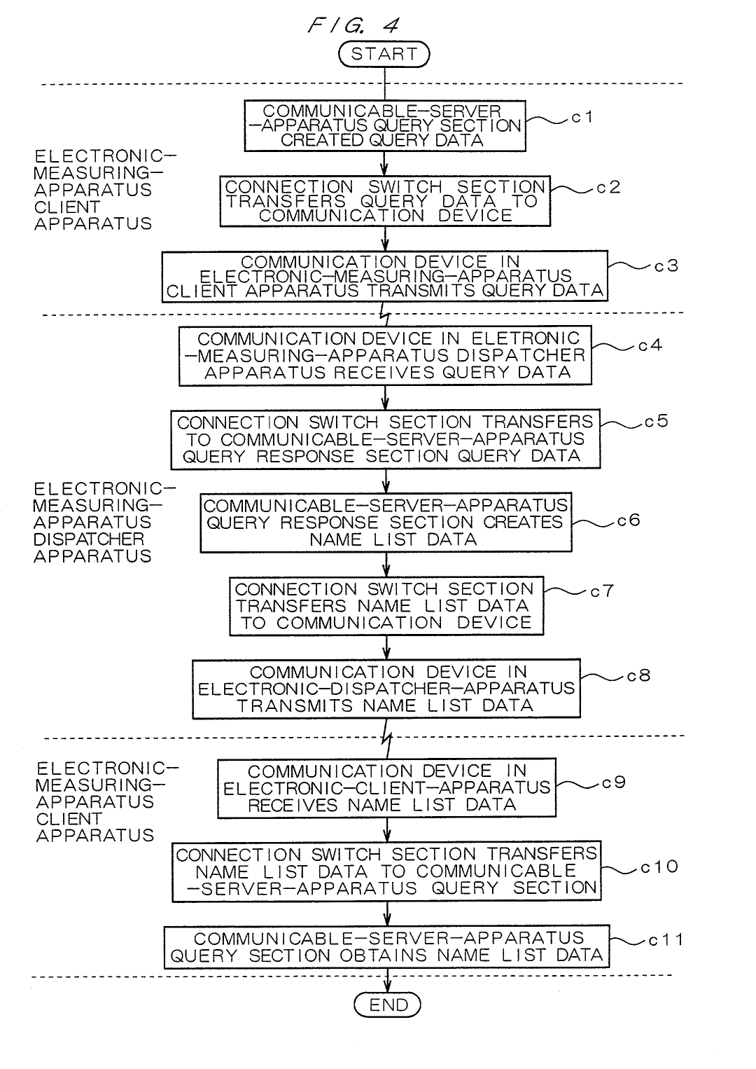

FIG. 4 is a flowchart showing a detailed operational procedure by which the electronic-measuring-apparatus client apparatus 100 obtains the list indicating the names of the electronic-measuring-apparatus server apparatuses 300 enabled to communicate in step a2 of FIG. 2. First, the communicable-server-apparatus query section 120 in the electronic-measuring-apparatus client apparatus 100 creates data for inquiry about the names of the electronic-measuring-apparatus server apparatuses 300 enabled to communicate (step c1). This data is transferred by the connection switch section 140 to the communication device 150 (step c2), which then transfers the data to Ethernet (step c3).

When the query data is transmitted from the communication device 150 in the electronic-measuring-apparatus client apparatus 100 to Ethernet in this manner, the communication device 250 in the electronic-measuring-apparatus dispatcher apparatus 200 receives this data (step c4), which is then transferred by the connection switch section 240 to the communicable-server-apparatus query response section 220 (step c5). The communicable-server-apparatus query response section 220 creates list data indicating the names of electronic-measuring-apparatus server apparatuses 300 enabled to communicate (step c6). The created name list data is transferred by the connection switch section 240 to the communication device 250 (step c7), which then transmits this list data to Ethernet (step c8).

When the name list data is sent to Ethernet, the communication device 150 in the electronic-measuring-apparatus client apparatus 100 receives this data (step c9), which is then transferred by the connection switch section 140 to the communicable-server-apparatus query section 120 (step c10). In this manner, the communicable-server-apparatus query section 120 obtains the name list data (step c11). This name list data includes the ID numbers of the electronic measuring apparatuses 310 included in the respective electronic-measuring-apparatus server apparatuses 300, and based on this data obtained, the electronic-measuring-apparatus client apparatus 100 can identify a controllable electronic measuring apparatus 310 and the electronic-measuring-apparatus server apparatus 300 including this apparatus 310.

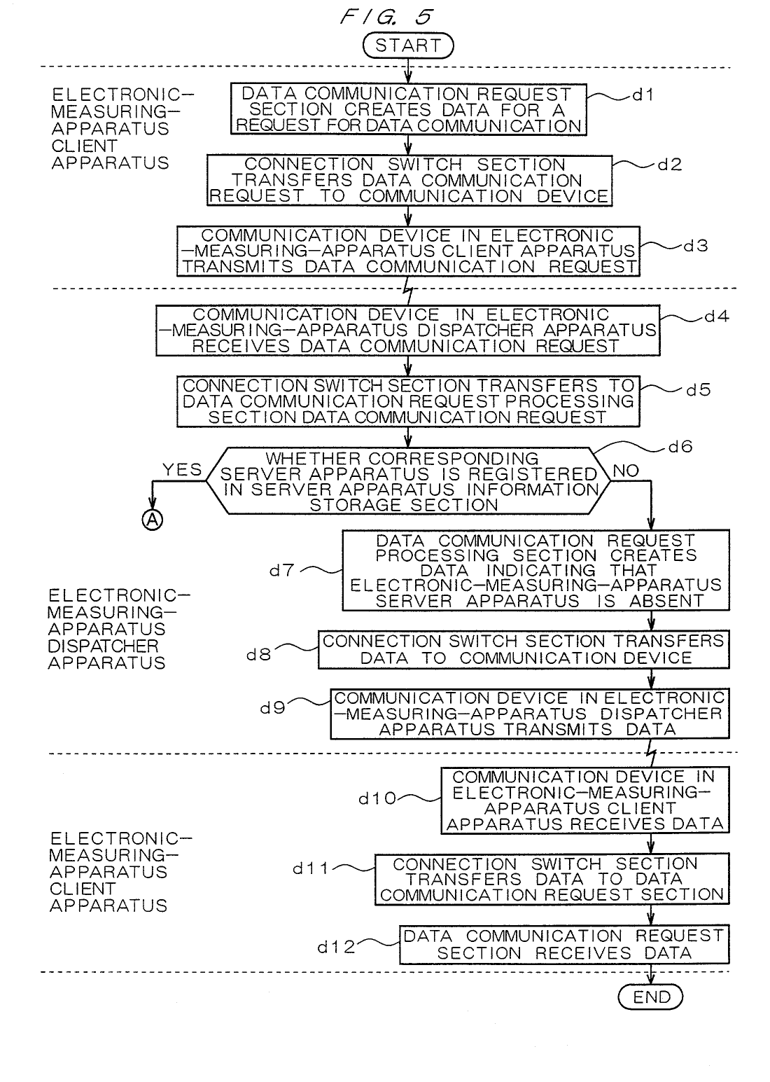

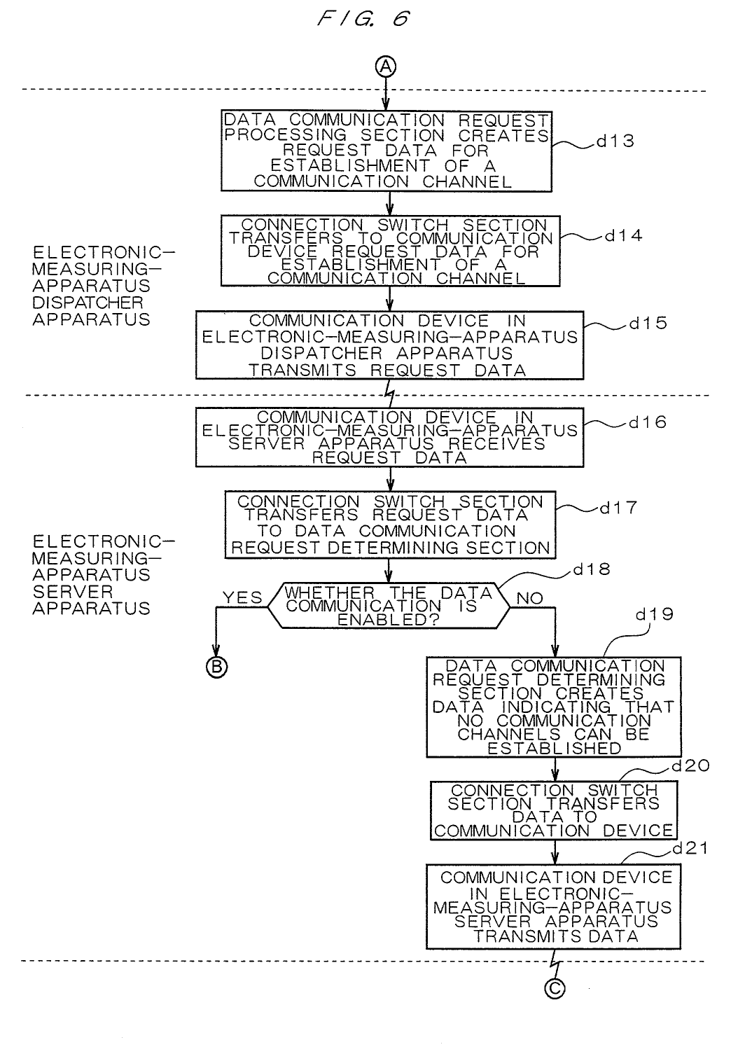

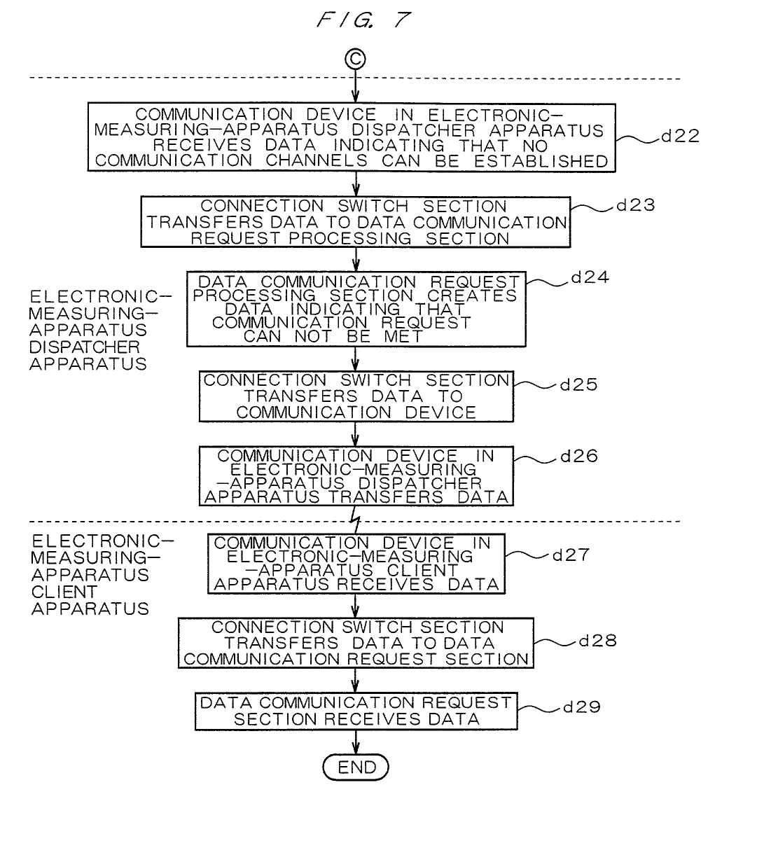

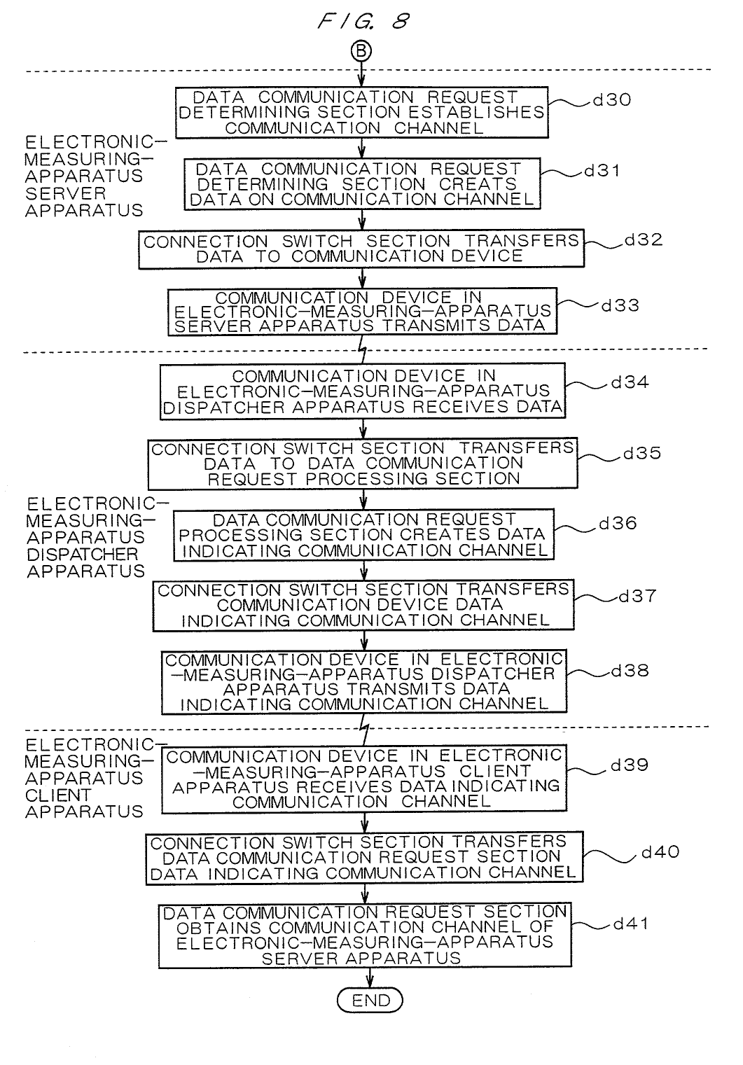

FIGS. 5 to 8 are a flowchart showing a detailed operational procedure from the output of data transmission request from the electronic-measuring-apparatus client apparatus 100 until the client apparatus 100 obtains a communication channel in steps a3 to a6 of FIG. 2. First, the data communication request section 130 in the electronic-measuring-apparatus client apparatus 100 creates data for a request for data communication, using the name of the electronic-measuring-apparatus server apparatus 300 including a desired electronic measuring apparatus 310 (step dl). This data is transferred by the connection switch section 140 to the communication device 150 (step d2), which then transmits the transferred data to Ethernet (step d3).

When the data for a request for data communication is transmitted to Ethernet from the communication device 150 in the electronic-measuring-apparatus client apparatus 100 in this manner, the communication device 250 in the electronic-measuring-apparatus dispatcher apparatus 200 receives this data (step d4), which is then transferred by the connection switch section 240 to the data communication request processing section 230 (step d5). Then, the data communication request processing section 230 determines whether the electronic-measuring-apparatus server apparatus 300 corresponding to this data communication request is registered in the server apparatus information storage section 210 (step d6).

If the electronic-measuring-apparatus server apparatus 300 having the name specified in the data communication request is not registered, the data communication request processing section 230 creates data indicating that the corresponding electronic-measuring-apparatus server apparatus 300 is absent (step d7). The created data is transferred by the connection switch section 240 to the communication device 250 (step d8), which then transmits this data to Ethernet (step d9).

When the data indicating the absence of the server apparatus is transmitted to Ethernet, the communication device 150 in the electronic-measuring-apparatus client apparatus 100 receives this data (step d10), which is then transferred by the connection switch section 140 to the data communication request section 130 (step d11). Based on this transferred data, the data communication request section 130 determines that the electronic-measuring-apparatus server apparatus 300 from which it has requested data communication is absent (step d12).

On the other hand, if the electronic-measuring-apparatus server apparatus 300 the name of which is specified in the data communication request is registered in the server apparatus information registration section 210, the result of the determination in the above step d6 is positive, and the data communication request processing section 230 in the electronic-measuring-apparatus dispatcher apparatus 200 creates data required for a request for the establishment of a communication channel that is to be sent to the relevant electronic-measuring-apparatus server apparatus 300 (step d13). The created data is transferred by the connection switch section 240 to the communication device 250 (step d14), which then transmits to Ethernet the data for a request for the establishment of a communication channel (step d15).

When the data is sent to Ethernet, the communication device 350 in the relevant electronic-measuring-apparatus server apparatus 300 receives this data (step d16), which is then transferred by the connection switch section 340 to the data communication request determining section 330 (step d17). Then, the data communication request determining section 330 determines from the transmitted request for the establishment of a communication channel whether a communication channel can be established for data communication (step d18).

If, for example, the relevant electronic measuring apparatus 310 is performing a predetermined operation under the control of another electronic-measuring-apparatus client apparatus 100, data is created indicating that no communication channels can be established (step d19). The created data is transferred by the connection switch section 340 to the communication device 350 (step d20), which then transmits to Ethernet the transferred data indicating that no communication channels can be established (step d21).

When the data is sent to Ethernet, the communication device 250 in the electronic-measuring-apparatus dispatcher apparatus 200 receives this data (step d22), which is then transferred by the connection switch section 240 to the data communication request processing section 230 (step d23). Based on the transferred data indicating that no communication channels can be established, the data communication request processing section 230 creates data indicating that the communication request cannot be met (step d24). This data is transferred by the connection switch section 240 to the communication device 250 (step d25), which then transmits the transferred data to Ethernet (step d26).

When communication device 250 in the electronic-measuring-apparatus dispatcher apparatus 200 transmits to Ethernet, data indicating that the communication request cannot be met, in the above manner, the communication device 150 in the electronic-measuring-apparatus client apparatus 100 receives this data (step d27), which is then transferred by the connection switch section 140 to the data communication request section 130 (step d28). The data communication request section 130 obtains the transferred data indicating that the communication request cannot be met to realize that it cannot communicate with the electronic-measuring-apparatus server apparatus 300 to which it has issued the data communication request (step d29).

On the other hand, if the relevant electronic measuring apparatus 310 is in a standby state and is available, the result of the determination in the above step d18 is positive, the data communication request determining section 330 in the electronic-measuring-apparatus server apparatus 300 establishes a communication channel (step d30) and creates data on the established communication channel (step d31). The created data is transferred by the connection switch section 340 to the communication device 350 (step d32), which then transmits the transferred data to Ethernet (step d33).

When the data on the communication channel is sent to Ethernet, the communication device 250 in the electronic-measuring-apparatus dispatcher apparatus 200 receives this data (step d34), which is then transferred by the connection switch section 240 to the data communication request processing section 230 (step d35). Based on the transferred data on the communication channel, the data communication request processing section 230 creates data indicating the communication channel established by the electronic-measuring-apparatus server apparatus 300 (step d36). This data is transferred by the connection switch section 240 to the communication device 250 (step d37), which then transmits the transferred data to Ethernet (step d38).

When the data indicating the established communication channel is sent to Ethernet, the communication device 150 in the electronic-measuring-apparatus client apparatus 100 receives this data (step d39), which is then transferred by the connection switch section 140 to the data communication request section 130 (step d40). Based on the transferred data indicating the communication channel, the data communication request section 130 obtains the communication channel to the electronic-measuring-apparatus server apparatus 300 (step d41). In this manner, a series of operations finishes that starts with a data communication request sent from the electronic-measuring-apparatus client apparatus 100 and that ends with the obtainment of a communication channel.

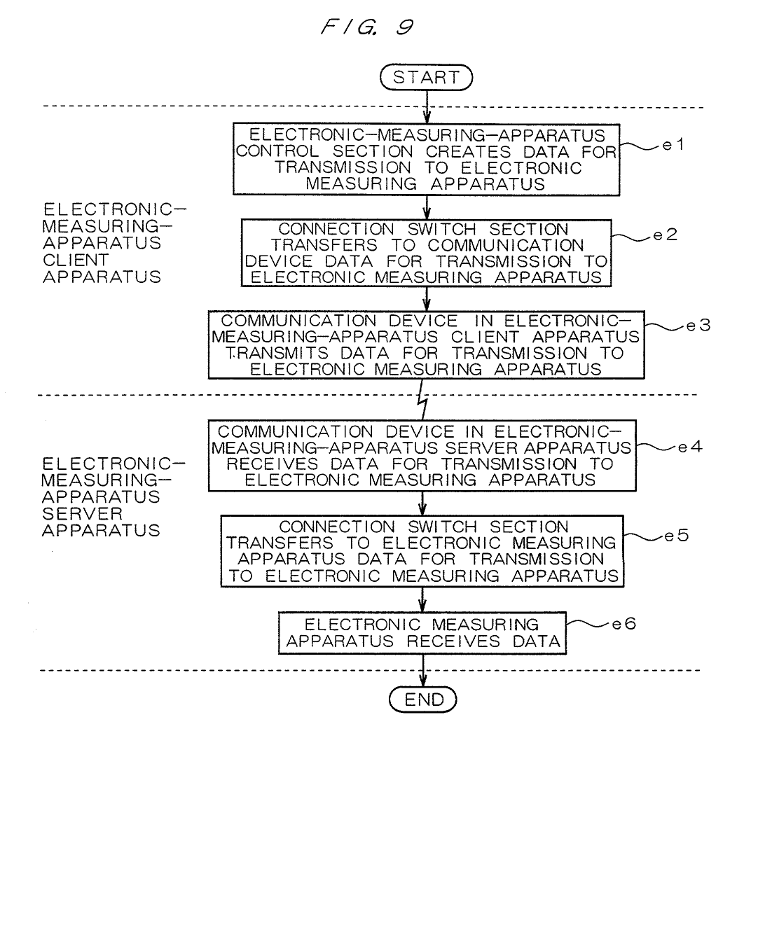

Next, a data transfer operation performed via the communication channel established in this manner is described. FIG. 9 shows an operational procedure by which the electronic-measuring-apparatus client apparatus 100 communicates data to the electronic-measuring-apparatus server apparatus 300.

First, the electronic-measuring-apparatus control section 110 in the electronic-measuring-apparatus client apparatus 100 creates data for transmission to the electronic measuring apparatus 310 of the electronic-measuring-apparatus server apparatus 300 (step e1). The created data is transferred by the connection switch section 140 to the communication device 150 (step e2), which then sends the transferred data to Ethernet (step e3).

When the data destined for the electronic measuring apparatus 310 is transmitted to Ethernet from the communication device 150 in the electronic-measuring-apparatus client apparatus 100, the communication device 350 in the electronic-measuring-apparatus server apparatus 300 receives this data (step e4), which is then transferred by the connection switch section 340 to the electronic measuring apparatus 310 (step e5). In this manner, the electronic measuring apparatus 310 obtains the data transmitted from the electronic-measuring-apparatus control section 110 in the electronic-measuring-apparatus client apparatus 100, for example, setting data for the electronic measuring apparatus 310 or various other data indicating an instruction for an operation or the transfer of the results of measurements (step e6).

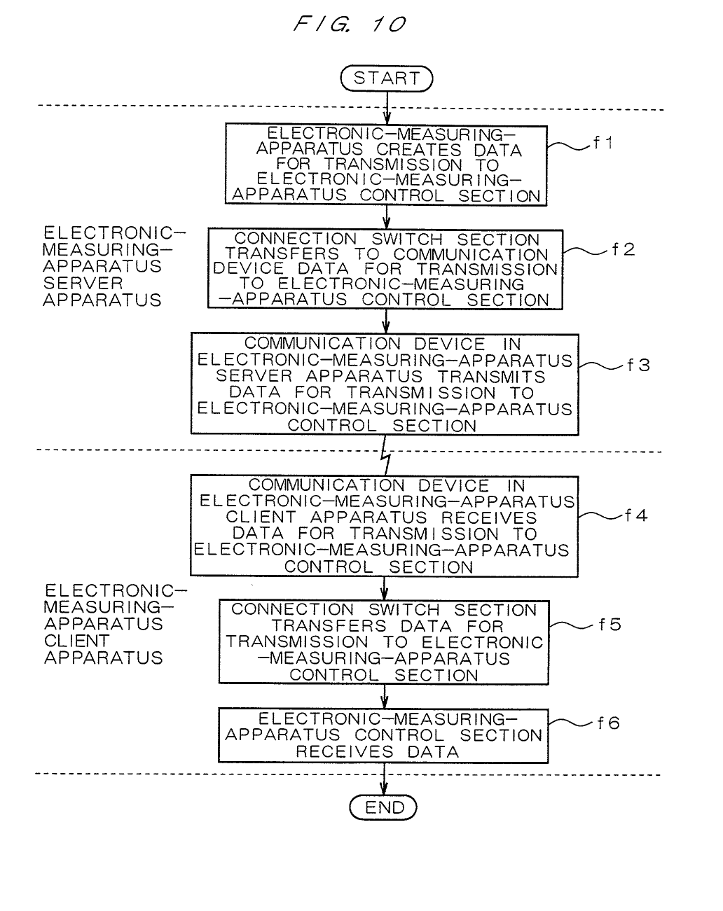

FIG. 10 shows an operational procedure by which the electronic-measuring-apparatus server apparatus 300 communicates data to the electronic-measuring-apparatus client apparatus 100. First, the electronic measuring apparatus 310 creates data for transmission to the electronic-measuring-apparatus client apparatus 100 (step f1). This data includes not only data obtained from measurements but also various other data indicating a status that indicates operational conditions or an alarm. The created data is transferred by the connection switch section 340 to the communication device 350 (step f2), which then sends the transferred data to Ethernet (step f3).

When the data output from the electronic measuring apparatus 310 is transmitted to Ethernet, the communication device 150 in the electronic-measuring-apparatus client apparatus 100 receives this data (step f4), which is then transferred by the connection switch section 140 to the electronic-measuring-apparatus control section 110 (step f5). In this manner, the electronic-measuring-apparatus control section 110 obtains various data transmitted from the electronic measuring apparatus 310 in the electronic-measuring-apparatus server apparatus 300 (step f6).

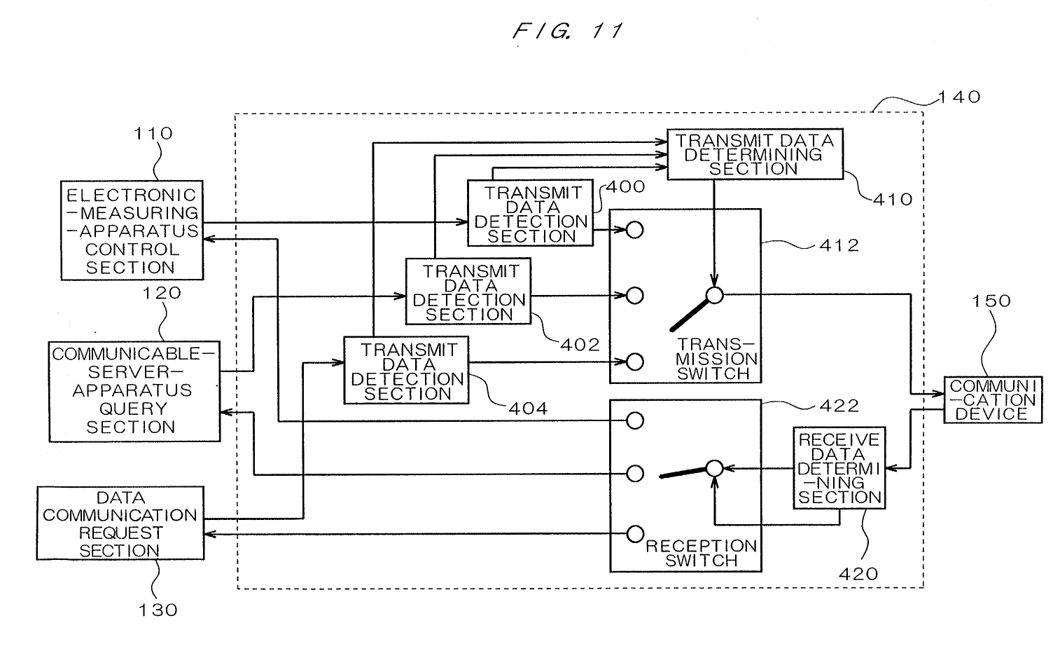

Next, the connection switch sections 140, 240, and 340 are described in detail that are included in the electronic-measuring-apparatus client apparatus 100, the electronic-measuring-apparatus dispatcher apparatus 200, and the electronic-measuring-apparatus server apparatus 300, respectively. FIG. 11 shows a detailed configuration of the connection switch section 140.

As shown in FIG. 11, the connection switch section 140 is composed of three transmit data detection sections 400, 402, and 404, a transmit data determining section 410, a transmission switch 412, and a receive data determining section 420, and a reception switch 422. The three transmit data detection sections 400, 402, and 404 are connected to the electronic-measuring-apparatus control section 110, the communicable-server-apparatus query section 120, and the data communication request section 130, respectively, and upon detecting transmit data output therefrom, output a transmit data presence signal to the transmit data determining section 410. The transmit data determining section 410 determines which of the transmit data detection sections 400 to 404 has input the transmit data presence signal, and then transmits to the transmission switch 412 a transmission switch signal depending on the result of the determination. The transmission switch 412 switches the connection state depending on the transmission switch signal input from the transmit data determining section 410 to connect the communication device 150 with one of the transmit data detection sections 400 to 404 that has detected the transmit data. Once the connection state has been switched in this manner, the transmit data detection section 400, 402, or 404 that has detected the transmit data transfers the transmit data to the communication device 150. In addition, upon finishing the transfer of the transmit data, the transmit data detection section 400, 402, or 404 outputs a transmit data transfer end signal to the transmit data determining section 410. Upon receiving the transmit data transfer end signal, the transmit data determining section 410 returns to a state in which it waits for a transmit data presence signal from the transmit data detection signals 400 to 404.

In addition, the receive data determining section 420 monitors the data reception state of the communication device 150, and upon detecting that the communication device 150 has received data, determines its destination based on this receive data to output a reception switch signal to the reception switch 422. The reception switch 422 switches the connection state depending on the reception switch signal input from the receive data determining section 420 to connect the communication device 150 with one of the electronic-measuring-apparatus control section 110, the communicable-server-apparatus query section 120, and the data communication request section 130 for which the receive data is destined.

The other connection switch sections 240 and 340 have the same configuration as the connection switch section 140. In the connection switch section 240, however, the three transmit data detection sections 400 to 404 are connected to each of the server apparatus information storage section 210, the communicable-server-apparatus query response section 220, and the data communication request processing section 230 so that the reception switch 422 transmits receive data to one of them. In addition, in the connection switch section 340, the three transmit data detection sections 400 to 404 are connected to each of the electronic measuring apparatus 310, the server apparatus information registration section 320, and the data communication request determining section 330 so that the reception switch 422 transmits receive data to one of them.

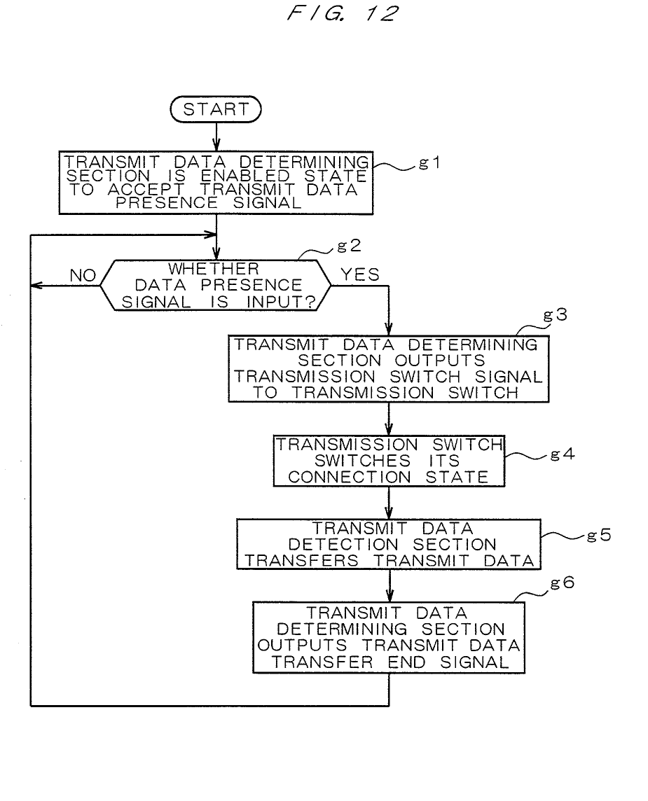

FIG. 12 is a flowchart showing an operational procedure for data transmission via the transmission switch 412 in the connection switch section 140. The transmit data determining section 410 has a switch enabled state in which it outputs a transmission switch signal and a switch disabled state in which it does not output a transmission switch signal. The transmit data determining section 410 is initially in the switch enabled state to accept the transmit data presence signal (step g1).

Then, the transmit data determining section 410 determines whether any of the transmit data detection sections 400 to 404 has input the transmit data presence signal (step g2), and if not, enters a state in which it waits for this signal. In addition, when the transmission data presence signal is input, the transmit data determining section 410 outputs the transmission switch signal to the transmission switch 412 (step g3) to switch its connection state (step g4). When the transmit data presence signal is input from one of the transmit data detection sections 400 to 404, the transmit data determining section 410 is changed from the switch enabled state to the disabled state so that an input transmit data presence signal will not cause the transmission switch signal to be output before the section 410 returns to the enabled state.

Then, after outputting the transmit data presence signal, the transmit data detection section 400, 402, or 404 transfers transmit data to the communication device 150 via the transmission switch 412 (step g5), and when this transfer operation finishes, outputs the transmit data transfer end signal to the transmit data determining section 410 (step g6). Upon receiving the transmit data transfer end signal, the transmit data determining section 410 is changed from the disabled state to the enabled state to enter the state in which it waits for the transmit data presence signal.

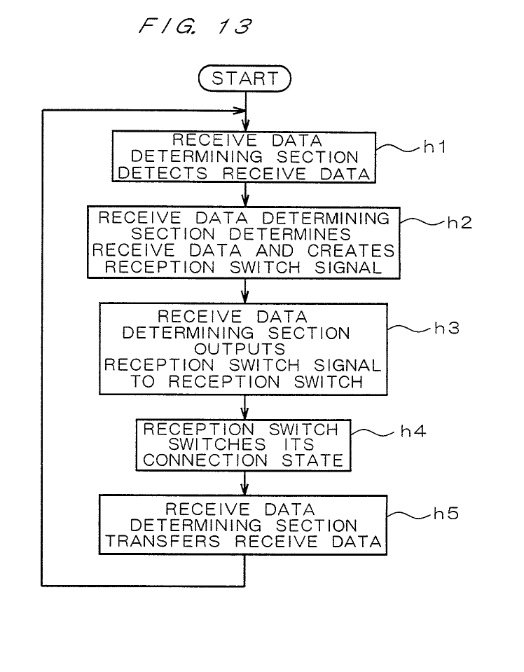

FIG. 13 is a flowchart showing an operational procedure for data reception via the reception switch 422 in the connection switch section 140. The receive data determining section 420 detects receive data transferred from the communication device 150 (step h1), creates a reception switch signal depending on the destination included in the receive data (step h2), and outputs the signal to the reception switch 422 (step h3) to switch the connection state of the reception switch 422 (step h4). After the receive data determining section 420 has been connected to the electronic-measuring-apparatus control section 110 for which the receive data is destined, in the above manner, the receive data determining section 420 transfers the receive data (step h5). When the receive data transfer operation has finished in this manner, the process returns to the above step hi to repeat the receive data monitor operation.

Next, a specific configuration is described in which the above electronic-measuring-apparatus communication system has been realized using different Ethernet systems. In the following description, 10Base-T, 10Base-5, and 10Base-2 are applied as specific examples of Ethernet. 10Base-T refers to a 10-Mbps baseband CSMA/CD LAN using twisted-pair cables of segment length 100 m or more. 10Base-5 refers to a 10-Mbps baseband CSMA/CD LAN using coaxial cables of segment length up to 500 m. 10Base-2 refers to a 10-Mbps baseband CSMA/CD LAN using coaxial cables of segment length up to 185 m.

### SPECIFIC EXAMPLE 1

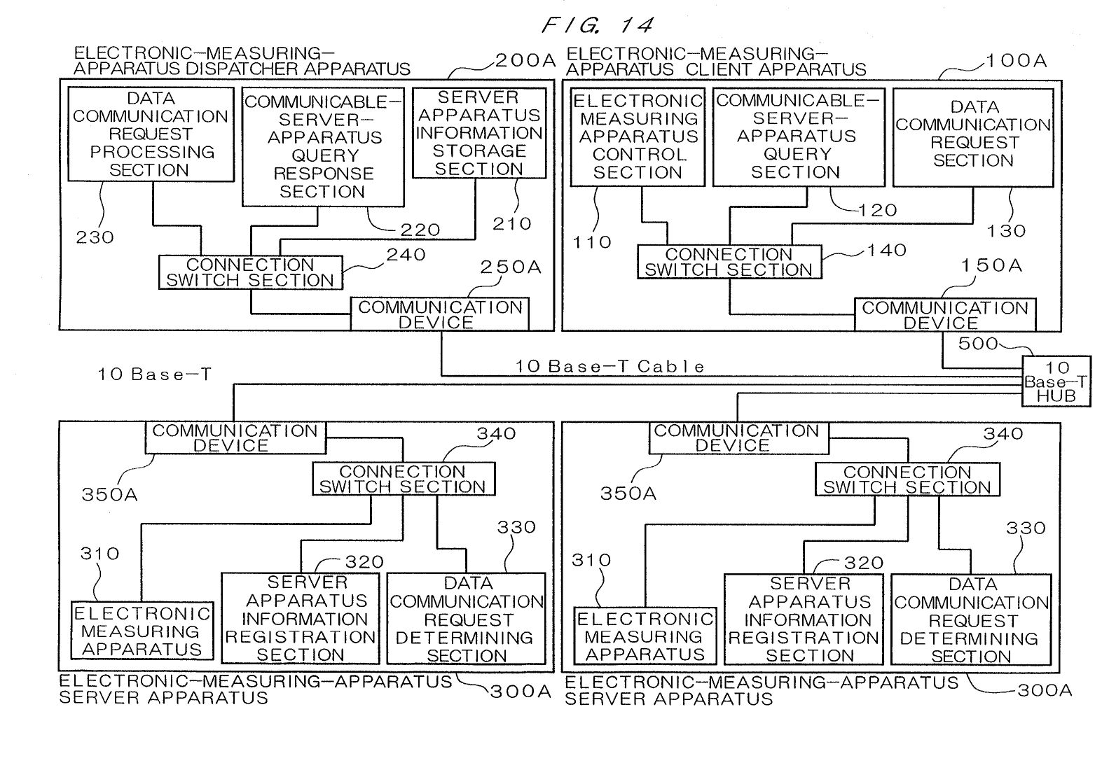

FIG. 14 shows a specific configuration of a connection method in an environment in which a plurality of computers are connected together using 10Base-T Ethernet cables. An electronic-measuring-apparatus client apparatus 100A, an electronic-measuring-apparatus dispatcher apparatus 200A, and two electronic-measuring-apparatus server apparatuses 300A, which are all shown in FIG. 14, are implementations of the corresponding apparatuses in FIG. 1 comprising computers. Communication devices 150A, 250A, and 350A in the respective apparatuses are connected via 10Base-T Ethernet cables to a 10Base-T HUB500 that is a relay apparatus.

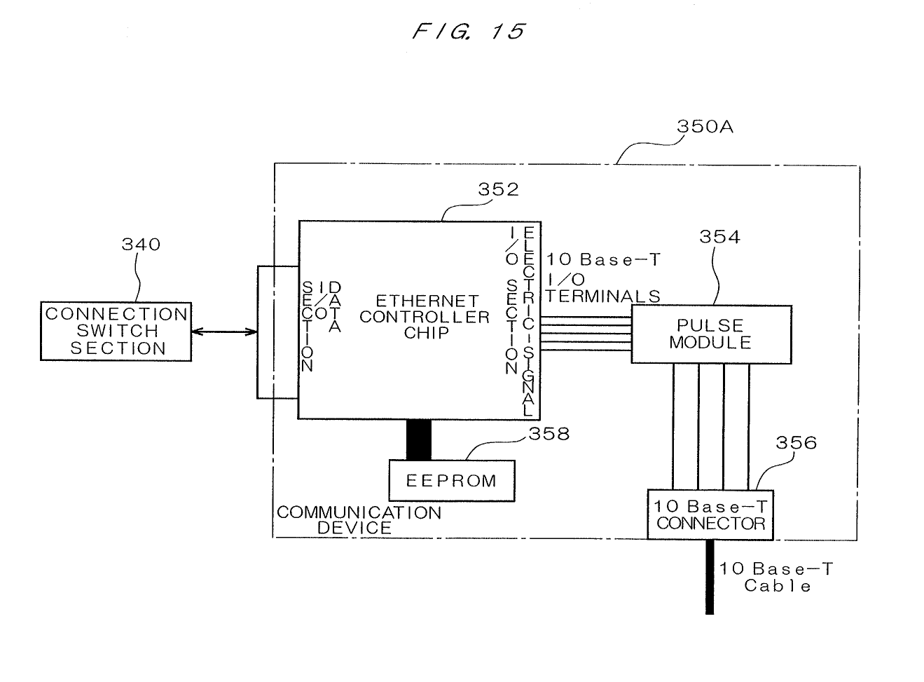

FIG. 15 shows a detailed configuration of the communication device 350A included in the electronic-measuring-apparatus server apparatus 300A. The communication device 150A included in the electronic-measuring-apparatus client apparatus 100A and the communication apparatus 250A included in the electronic-measuring-apparatus dispatcher apparatus 200A have similar configurations, so the communication device 350A is described as a representative.

As shown in FIG. 15, the communication device 350A is composed of an Ethernet controller chip 352, a pulse module 354, a 10Base-T connector 356, and an EEPROM 358. The Ethernet controller chip 352 comprises, for example, Am79C760 manufactured by AMD Corp. and has a data I/O section to and from which data is input and output and an electric-signal I/O section to and from which electric signals on Ethernet are input and output. The electric-signal I/O section includes 10Base-T I/O terminals and AUI (Attachment Unit Interface) I/O terminals, and the 10Base-T I/O terminals are connected to the pulse module 354.

The pulse module 354 comprises, for example, PM02-04 manufactured by Toko Corp., shapes the waveform of electric signals, and insulates the cable from the Ethernet controller chip 352. The pulse module 354 is connected to the Ethernet cable via the 10Base-T connector 356. The Ethernet controller chip 352 constantly receives electric signals on the 10Base-T Ethernet cable via the pulse module 354 and the 10Base-T connector 356.

The EEPROM 358 stores an ID number different from those of the other communication devices such as the communication device 150A. The Ethernet controller chip 352 reads the ID number stored in the EEPROM 358 and uses this number as its own ID number.

When data is input to the data I/O section, the Ethernet controller chip 352 generates and transmits a packet. The packet is sent by converting the data constituting the packet into an electric signal and transmitting this signal to the 10Base-T Ethernet cable. The packet is composed of a preamble, a destination Ethernet chip ID number, a source Ethernet chip ID number, and transferred data. The preamble is specific data that is added to the beginning of the packet when the electric signal is sent to the 10Base-T Ethernet cable.

This packet is transmitted to the Ethernet controller chip 352 included in another communication device such as the communication device 150A corresponding to the destination Ethernet controller chip ID number. In addition, the source Ethernet chip ID number is automatically inserted into the packet by the Ethernet controller chip 352.

In transmitting a packet, the Ethernet controller chip 352 confirms that no electric signal is flowing through the 10Base-T Ethernet cable. If there is an electric signal flowing through the cable, the packet must wait until there is no electric signal in the cable. Otherwise, the Ethernet controller chip 352 outputs from the electric-signal I/O section an electric signal obtained by sequentially encoding the data in the packet starting with its head. The encoded electric signal has its waveform shaped by the pulse module 354 and is output to the 10Base-T cable via the 10Base-T connector 356.

In addition, the Ethernet controller chip 352 constantly receives an electric signal on the 10Base-T Ethernet cable, and decodes the received signal to create a packet. In addition, the Ethernet controller chip 352 determines whether the destination Ethernet chip ID number of the created packet is the same as its own ID number, and if not, abandons the received packet. Otherwise, the destination Ethernet controller chip ID number, source Ethernet controller chip ID number, and transferred data included in the packet are output from the data I/O section.

Next, the operation of the electronic-measuring-apparatus communication system shown in FIG. 14 is described. For example, the server apparatus information registration section 320 in the electronic-measuring-apparatus server apparatus 300A creates transmit data. The transmit data includes transferred data including source information that enables the server apparatus information registration section 320 to be determined to have created the transmit data and the Ethernet controller chip ID numbers of the communication devices such as the destination communication device 150A. The transmit data produced by the server apparatus information registration section 320 is transferred by the connection switch section 340 to the communication device 350A.

The communication device 350A creates a packet from the transferred transmit data, converts the packet into an electric signal, and sends the signal to the 10Base-T Ethernet cable. In this manner, the transmit data produced by the server apparatus information registration section 320 (or the electronic measuring apparatus 310 or the data communication request section 330) is transmitted to the 10Base-T Ethernet cable.

In addition, upon receiving a packet specifying the Ethernet controller chip 352 as a destination, the communication device 350A in the electronic-measuring-apparatus server apparatus 300A extracts and outputs from this packet, the destination Ethernet controller chip ID number, the source Ethernet controller chip ID number, and the transferred data. The connection switch section 340 determines the destination based on the source information included in the transferred data output from the communication device 350A, and transfers the transferred data to, for example, the server apparatus information registration section 320.

The above description is also applicable if another structure in the electronic-measuring-apparatus server apparatus 300A (the electronic measuring apparatus 310 or the data communication request determining section 330) is used to send or receive data, or if any structure in the electronic-measuring-apparatus client apparatus 100A (the electronic-measuring-apparatus control section 110, the communicable-server-apparatus query section 120, or the data communication request section 130) or in the electronic-measuring-apparatus dispatcher apparatus 200A (the server apparatus information storage section 210, the communicable-server-apparatus query response section 220, or the data communication request processing section 230) is used to send or receive data.

### SPECIFIC EXAMPLE 2

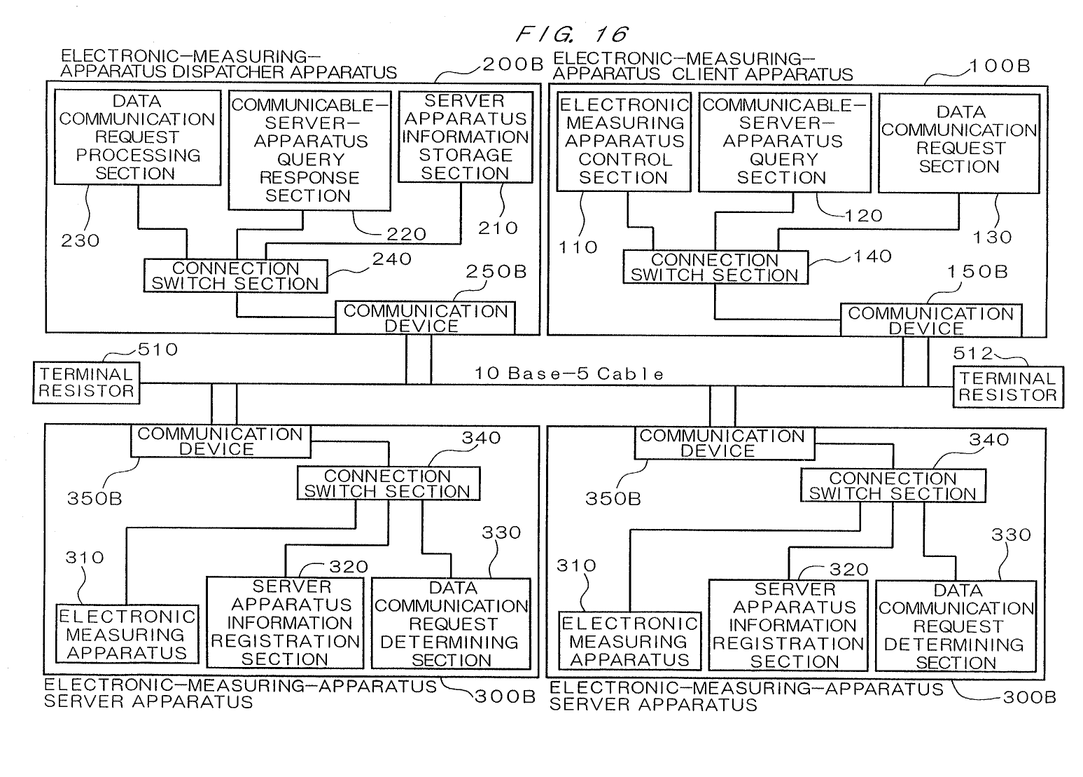

FIG. 16 shows a specific configuration of a connection method in an environment in which a plurality of computers are connected together using 10Base-5 Ethernet cables. An electronic-measuring-apparatus client apparatus 100B, an electronic-measuring-apparatus dispatcher apparatus 200B, and two electronic-measuring-apparatus server apparatuses 300B, which are all shown in FIG. 16, are implementations of the corresponding apparatuses in FIG. 1 comprising computers. Communication devices 150B, 250B, and 350B in the respective apparatuses are connected to a 10Base-5 Ethernet cable both ends of which are terminated by terminal resistors 510 and 512.

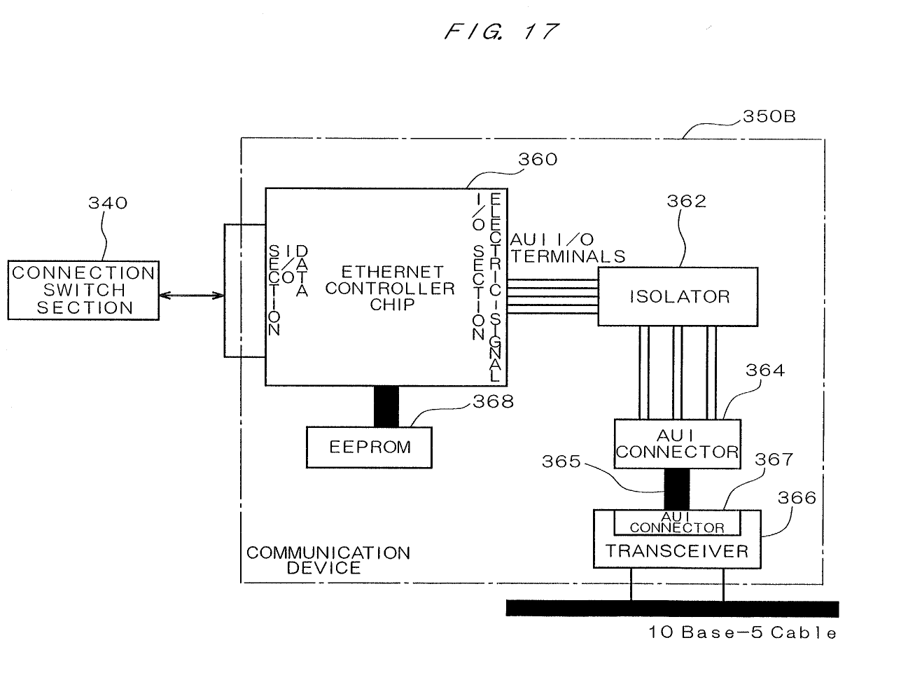

FIG. 17 shows a detailed configuration of the communication device 350B included in the electronic-measuring-apparatus server apparatus 300B. The communication device 150B included in the electronic-measuring-apparatus client apparatus 100B and the communication apparatus 250B included in the electronic-measuring-apparatus dispatcher apparatus 200B have similar configurations, so the communication device 350B is described as a representative.

As shown in FIG. 17, the communication device 350B is composed of an Ethernet controller chip 360, an isolator 362, an AUI connector 364, a transceiver 366, and an EEPROM 368. The Ethernet controller chip 360 comprises, for example, Am79C960 manufactured by AMD Corp. and has a data I/O section to and from which bit string data is input and output and an electric-signal I/O section to and from which electric signals on Ethernet are input and output. The electric-signal I/O section includes 10Base-T I/O terminals and AUI I/O terminals, which are connected to the isolator 362.

The isolator 362 isolates the Ethernet controller chip 360 from the AUI connector 364. The transceiver 366 receives an electric signal from the 10Base-5 Ethernet cable to convert it into an electric signal corresponding to AUI, and includes an AUI connector 367 to connect to the isolator 362. The AUI connector 364 on the isolator 362 is connected to the AUI connector 364 on the transceiver 366 using an AUI cable 365. The Ethernet controller chip 360 constantly receives electric signals on the 10Base-5 Ethernet cable.

The EEPROM 368 stores an ID number different from those of the other communication devices such as the communication device 150B. The Ethernet controller chip 360 reads the ID number stored in the EEPROM 368 and uses this number as its own ID number.

When data is input to the data I/O section, the Ethernet controller chip 360 generates and transmits a packet. The packet is sent by converting the data constituting the packet into an electric signal and transmitting this signal to the 10Base-5 Ethernet cable via the isolator 362, the AUI cable 365, and the transceiver 366. The packet is composed of a preamble, a destination Ethernet chip ID number, a source Ethernet chip ID number, and transferred data.

This packet is transmitted to the Ethernet controller chip 360 included in another communication device such as the communication device 150B corresponding to the destination Ethernet controller chip ID number. In addition, the source Ethernet chip ID number is automatically inserted into the packet by the Ethernet controller chip 360.

In transmitting a packet, the Ethernet controller chip 360 confirms via the isolator 362, the AUI cable 365, and the transceiver 366 that no electric signal is flowing through the 10Base-5 Ethernet cable. If there is an electric signal flowing through the cable, the packet must wait until there is no electric signal in the cable. Otherwise, the Ethernet controller chip 360 outputs from the electric-signal I/O section an electric signal obtained by sequentially encoding the data in the packet starting with its head. The encoded electric signal is output to the 10Base-5 cable via the isolator 362, the AUI cable 365, and the transceiver 366.

In addition, the Ethernet controller chip 360 constantly receives an electric signal on the 10Base-5 Ethernet cable via the isolator 362, the AUI cable 365, and the transceiver 366, and decodes the received signal to create a packet. In addition, the Ethernet controller chip 360 determines whether the destination Ethernet chip ID number of the created packet is the same as its own ID number, and if not, abandons the received packet. Otherwise, the destination Ethernet controller chip ID number, source Ethernet controller chip ID number, and transferred data included in the packet are output from the data I/O section.

Next, the operation of the electronic-measuring-apparatus communication system shown in FIG. 16 is described. For example, the server apparatus information registration section 320 in the electronic-measuring-apparatus server apparatus 300B creates transmit data. The transmit data includes transferred data including source information that enables the server apparatus information registration section 320 to be determined to have created the transmit data and the Ethernet controller chip ID numbers of the communication devices such as the destination communication device 150B. The transmit data produced by the server apparatus information registration section 320 is transferred by the connection switch section 340 to the communication device 350B.

The communication device 350B creates a packet from the transferred transmit data, converts the packet into an electric signal, and sends the signal to the 10Base-5 Ethernet cable. In this manner, the transmit data produced by the server apparatus information registration section 320 (or the electronic measuring apparatus 310 or the data communication request section 330) is transmitted to the 10Base-5 Ethernet cable.

In addition, upon receiving a packet specifying the Ethernet controller chip 360 as a destination, the communication device 350B in the electronic-measuring-apparatus server apparatus 300B extracts and outputs from this packet, the destination Ethernet controller chip ID number, the source Ethernet controller chip ID number, and the transferred data. The connection switch section 340 determines the destination based on the source information included in the transferred data output from the communication device 350B, and transfers the transferred data to, for example, the server apparatus information registration section 320.

The above description is also applicable if another structure in the electronic-measuring-apparatus server apparatus 300B (the electronic measuring apparatus 310 or the data communication request determining section 330) is used to send or receive data, or if any structure in the electronic-measuring-apparatus client apparatus 100B (the electronic-measuring-apparatus control section 110, the communicable-server-apparatus query section 120, or the data communication request section 130) or in the electronic-measuring-apparatus dispatcher apparatus 200B (the server apparatus information storage section 210, the communicable-server-apparatus query response section 220, or the data communication request processing section 230) is used to send or receive data.

### SPECIFIC EXAMPLE 3

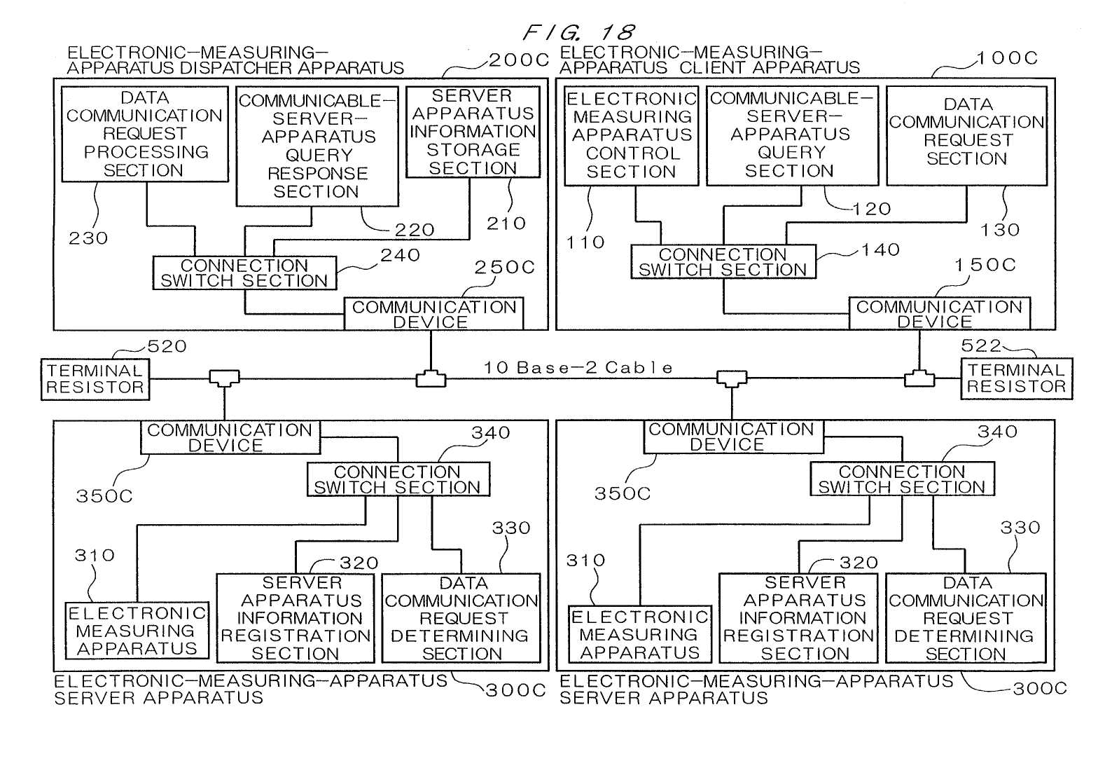

FIG. 18 shows a specific configuration of a connection method in an environment in which a plurality of computers are connected together using 10Base-2 Ethernet cables. An electronic-measuring-apparatus client apparatus 100C, an electronic-measuring-apparatus dispatcher apparatus 200C, and two electronic-measuring-apparatus server apparatuses 300C, which are all shown in FIG. 18, are implementations of the corresponding apparatuses in FIG. 1 comprising computers. Communication devices 150C, 250C, and 350C in the respective apparatuses are connected to a 10Base-2 Ethernet cable both ends of which are terminated by terminal resistors 520 and 522.

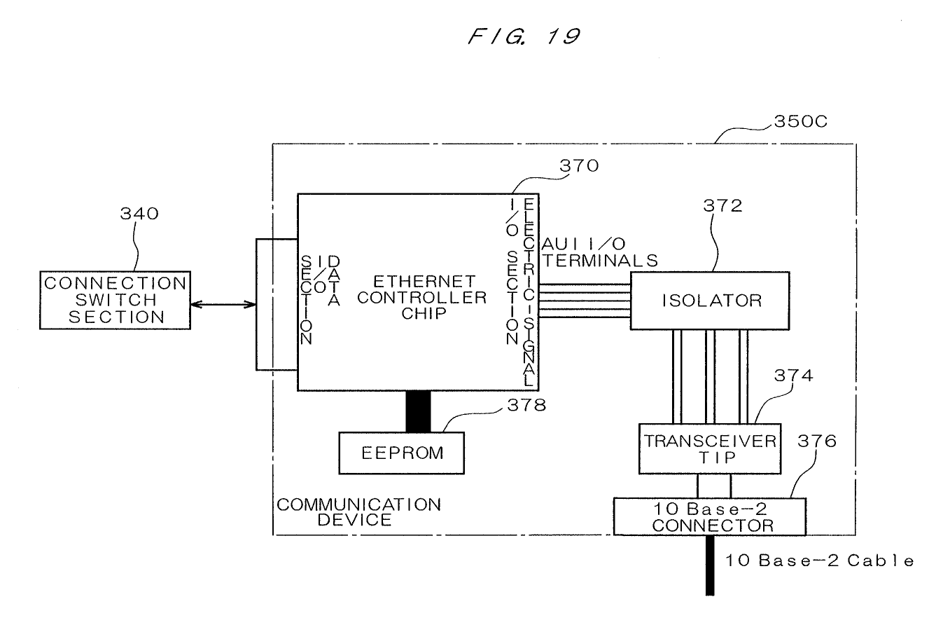

FIG. 19 shows a detailed configuration of the communication device 350C included in the electronic-measuring-apparatus server apparatus 300C. The communication device 150C included in the electronic-measuring-apparatus client apparatus 100C and the communication apparatus 250C included in the electronic-measuring-apparatus dispatcher apparatus 200C have similar configurations, so the communication device 350C is described as a representative.

As shown in FIG. 19, the communication device 350C is composed of an Ethernet controller chip 370, an isolator 372, a transceiver chip 374, a 10Base-2 connector 376, and an EEPROM 378. The Ethernet controller chip 370 comprises, for example, Am79C960 manufactured by AMD Corp. and has a data I/O section to and from which bit string data is input and output and an electric-signal I/O section to and from which electric signals on Ethernet are input and output. The electric-signal I/O section includes 10Base-T I/O terminals and AUI I/O terminals, which are connected to the isolator 372.

The isolator 372 isolates the Ethernet controller chip 370 from the transceiver chip 374. The 10Base-2 connector 376 connects Ethernet I/O terminals of the transceiver chip 374 to the 10Base-2 Ethernet cable. The transceiver chip 374 comprises, for example, DP8392 manufactured by NS Corp. and converts an electric signal on the 10Base-2 Ethernet cable into one corresponding to the AUI. The Ethernet controller chip 370 constantly receives electric signals on the 10Base-2 Ethernet cable.

The EEPROM 378 stores an ID number different from those of the other communication devices such as the communication device 150C. The Ethernet controller chip 370 reads the ID number stored in the EEPROM 378 and uses this number as its own ID number.

When data is input to the data I/O section, the Ethernet controller chip 370 generates and transmits a packet. The packet is sent by converting the data constituting the packet into an electric signal and transmitting this signal to the 10Base-2 Ethernet cable via the transceiver chip 374. The packet is composed of a preamble, a destination Ethernet chip ID number, a source Ethernet chip ID number, and transferred data.

This packet is transmitted to the Ethernet controller chip 370 included in another communication device such as the communication device 150C corresponding to the destination Ethernet controller chip ID number. In addition, the source Ethernet chip ID number is automatically inserted into the packet by the Ethernet controller chip 370.

In transmitting a packet, the Ethernet controller chip 370 confirms via the transceiver chip 374 that no electric signal is flowing through the 10Base-2 Ethernet cable. If there is an electric signal flowing through the cable, the packet must wait until there is no electric signal in the cable. Otherwise, the Ethernet controller chip 370 outputs from the electric-signal I/O section an electric signal obtained by sequentially encoding the data in the packet starting with its head. The encoded electric signal has its waveform shaped by the isolator 372 and is output to the 10Base-2 cable via the transceiver chip 374 and the 10Base-2 connector 376.

In addition, the Ethernet controller chip 370 constantly receives an electric signal on the 10Base-2 Ethernet cable via the transceiver chip 374, and decodes the received signal to create a packet. In addition, the Ethernet controller chip 370 determines whether the destination Ethernet chip ID number of the created packet is the same as its own ID number, and if not, abandons the received packet. Otherwise, the destination Ethernet controller chip ID number, source Ethernet controller chip ID number, and transferred data included in the packet are output from the data I/O section.

Next, the operation of the electronic-measuring-apparatus communication system shown in FIG. 18 is described. For example, the server apparatus information registration section 320 in the electronic-measuring-apparatus server apparatus 300C creates transmit data. The transmit data includes transferred data including source information that enables the server apparatus information registration section 320 to be determined to have created the transmit data and the Ethernet controller chip ID numbers of the communication devices such as the destination communication device 150C. The transmit data produced by the server apparatus information registration section 320 is transferred by the connection switch section 340 to the communication device 350C.

The communication device 350C creates a packet from the transferred transmit data, converts the packet into an electric signal, and sends the signal to the 10Base-2 Ethernet cable. In this manner, the transmit data produced by the server apparatus information registration section 320 (or the electronic measuring apparatus 310 or the data communication request section 330) is transmitted to the 10Base-2 Ethernet cable.

In addition, upon receiving a packet specifying the Ethernet controller chip 370 as a destination, the communication device 350C in the electronic-measuring-apparatus server apparatus 300C extracts and outputs from this packet, the destination Ethernet controller chip ID number, the source Ethernet controller chip ID number, and the transferred data. The connection switch section 340 determines the destination based on the source information included in the transferred data output from the communication device 350C, and transfers the transferred data to, for example, the server apparatus information registration section 320.

The above description is also applicable if another structure in the electronic-measuring-apparatus server apparatus 300C (the electronic measuring apparatus 310 or the data communication request determining section 330) is used to send or receive data, or if any structure in the electronic-measuring-apparatus client apparatus 100C (the electronic-measuring-apparatus control section 110, the communicable-server-apparatus query section 120, or the data communication request section 130) or in the electronic-measuring-apparatus dispatcher apparatus 200C (the server apparatus information storage section 210, the communicable-server-apparatus query response section 220, or the data communication request processing section 230) is used to send or receive data.

This invention is not limited to the above embodiments, but various variations may be made thereto within its spirits. For example, although the above embodiments provide each electronic-measuring-apparatus server apparatus 300 with a single electronic measuring apparatus 310, each electronic-measuring-apparatus server apparatus 300 may include a plurality of electronic measuring apparatuses 310 that can execute the same or different measurements. In addition, although the specific examples of Ethernet connecting the apparatuses together include 10Base-T, 10Base-5, and 10Base-2, other local or wide area networks may be used to connect the apparatuses together.

According to the above mentioned embodiments, when the power is applied to each electronic measuring apparatus 310, the registered information data transmitted from the electronic-measuring-apparatus server apparatus 300 to the electronic-measuring-apparatus dispatcher apparatus 200 contains the name of the electronic-measuring-apparatus server apparatus 300, which is the source of the registered information data, and the ID number of the electronic measuring apparatus 310 connected to the electronic-measuring-apparatus server apparatus 300. The registered information data can further contain the information specific to each electronic measuring apparatus 310.

Especially, in the case of an electronic measuring apparatus network where a remote operation is performed by connecting a plurality of electronic measuring apparatuses 310 through a network, the network can be quite different in characteristics from a computer network to which a plurality of servers comprising basically the same configurations are connected. That is, each electronic measuring apparatus 310 has different items to be measured for each model, and the specifications can be quite different for the same model in many cases. Therefore, when a number of electronic measuring apparatuses 310 having different items to be measured and specifications are connected to a network, it is desirable that the registered information data generated when the power is applied to each electronic measuring apparatus 310 contains the detailed information about the type of the service provided by using the electronic measuring apparatus 310 and the measurement specification together with the name of the server 300 and the ID number of the electronic measuring apparatus 310.

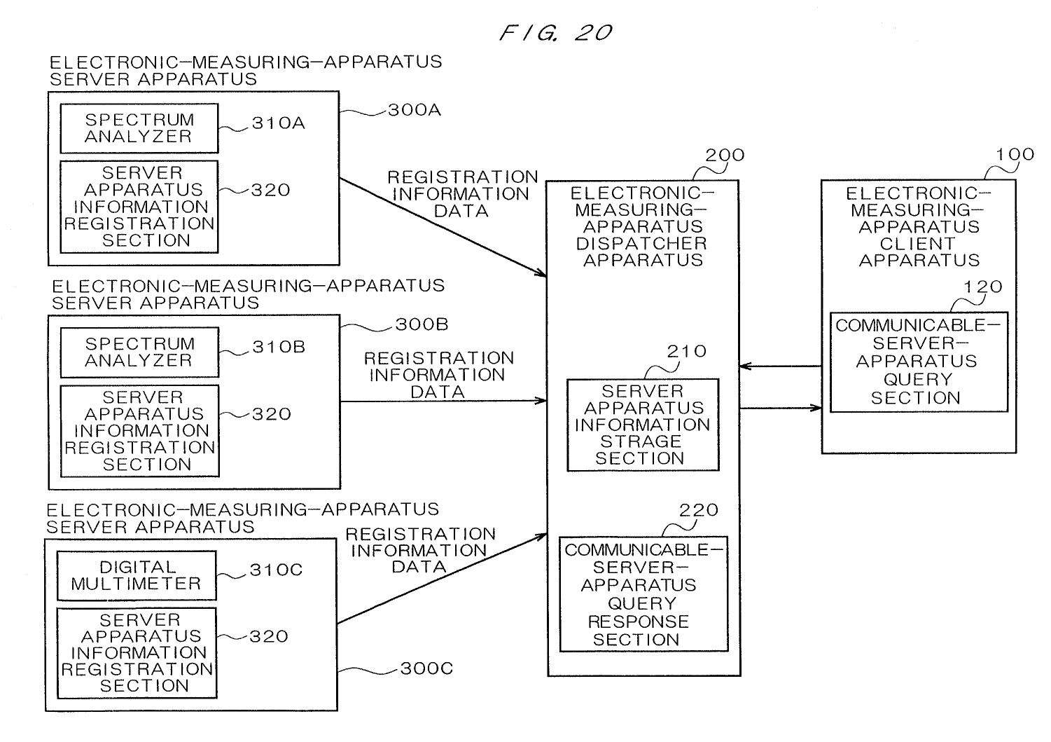

FIG. 20 shows an explaining view of a variation of the electronic-measuring-apparatus communications system using the registered information data containing the detailed information. The electronic-measuring-apparatus communications system shown in FIG. 20 has basically the same configuration as the electronic-measuring-apparatus communications system shown in FIG. 1, and is configured by an electronic-measuring-apparatus client apparatus 100, an electronic-measuring-apparatus dispatcher apparatus 200, and three electronic-measuring-apparatus server apparatuses 300A, 300B, and 300C. The three electronic-measuring-apparatus server apparatuses 300A, 300B, and 300C have the same basic configurations as the electronic-measuring-apparatus server apparatus 300 shown in FIG. 1, and are different from it only in that the electronic measuring apparatus 310 represented as a general-purpose apparatus is replaced with a measuring apparatus assigned a concrete name.

Concretely, a spectrum analyzer 310A is connected as the electronic measuring apparatus 310 to the electronic-measuring-apparatus server apparatus 300A. The spectrum analyzer 310A provides a service of measuring power spectrum data, and has the measurement specification of “the upper limit of the measurement frequency of 3 GHz.”

A spectrum analyzer 310B is connected as the electronic measuring apparatus 310 to the electronic-measuring-apparatus server apparatus 300B. The spectrum analyzer 310B provides a service of measuring a power spectrum data, and has the measurement specification of “the upper limit of the measurement frequency of 26 GHz.”

A digital multimeter 310C is connected as the electronic measuring apparatus 310 to the electronic-measuring-apparatus server apparatus 300C. The digital multimeter 310C provides two services of measuring voltage data and measuring current data, and has the measurement specification of a measurement range and measurement precision.

Described below will be the operation of transmitting and receiving registered information data and list data in the electronic-measuring-apparatus communications system shown in FIG. 20.

For example, when the power is applied to the spectrum analyzer 310A, the server apparatus information registration section 320 in the electronic-measuring-apparatus server apparatus 300A generates registered information data containing the name of the electronic-measuring-apparatus server apparatus 300A, the ID number of the spectrum analyzer 310A, the provided service information “measurement of power spectrum data,” and the measurement specification “the upper limit of the measurement frequency of 3 GHz” (step b2 shown in FIG. 3). The registered information data is transmitted to the electronic-measuring-apparatus dispatcher apparatus 200, and stored in the server apparatus information storage section 210.

Similarly, when the power is applied to the spectrum analyzer 310B, the server apparatus information registration section 320 in the electronic-measuring-apparatus server apparatus 300B generates registered information data containing the name of the electronic-measuring-apparatus server apparatus 300B, the ID number of the spectrum analyzer 310B, the provided service information “measurement of power spectrum data,” and the measurement specification “the upper limit of the measurement frequency of 26 GHz.” The registered information data is transmitted to the electronic-measuring-apparatus dispatcher apparatus 200, and stored in the server apparatus information storage section 210.

When the power is applied to the digital multimeter 310C, the server apparatus information registration section 320 in the electronic-measuring-apparatus server apparatus 300C generates registered information data containing the name of the electronic-measuring-apparatus server apparatus 300C, the ID number of the spectrum analyzer 310C, the provided service information “measurement of voltage data and current data,” and the measurement specification “measured range XXX, measurement precision YYY.” The registered information data is transmitted to the electronic-measuring-apparatus dispatcher apparatus 200, and stored in the server apparatus information storage section 210.

It is desirable that the communicable-server-apparatus query section 120 in the electronic-measuring-apparatus client apparatus 100 generates data for inquiry of the name of a communicable electronic-measuring-apparatus server apparatus including the contents of the services and the measurement specification required in measurement when the data is generated (step c1 shown in FIG. 4). Thus, the communicable-server-apparatus query response section 220 in the electronic-measuring-apparatus dispatcher apparatus 200 which receives the data is a communicable electronic-measuring-apparatus server apparatus, and generates list data by selecting the contents of the services and the data satisfying the request of the measurement specification contained in the received data. Therefore, the communicable-server-apparatus query section 120 in the electronic-measuring-apparatus client apparatus 100 which receives the list data can know the name of the electronic-measuring-apparatus server apparatus to which an electronic measuring apparatus (for example, the spectrum analyzer 310A) having a predetermined measurement specification and a desired measuring function is connected. When the names of two or more electronic-measuring-apparatus server apparatuses are contained in the list data, desired measurement can be made using the electronic measuring apparatus connected to any of the apparatuses. Therefore, the communicable-server-apparatus query section 120 can select any electronic-measuring-apparatus server apparatus from among the apparatuses.

In the above mentioned example, when the communicable-server-apparatus query response section 220 in the electronic-measuring-apparatus dispatcher apparatus 200 generates list data, only the electronic-measuring-apparatus server apparatus which satisfies the conditions of the contents of the services and the measurement specification is extracted. However, the list data containing the names, the service providing information, and the measurement specifications of all communicable electronic-measuring-apparatus server apparatuses can be generated and transmitted to the electronic-measuring-apparatus client apparatus 100. In this case, the communicable-server-apparatus query section 120 in the electronic-measuring-apparatus client apparatus 100 can select an electronic-measuring-apparatus server apparatus which satisfies the conditions of the contents of the services and the measurement specifications from the list data.

1. An automatic remote electronic instrument connecting system comprising:
server apparatuses to which electronic measuring apparatuses are connected;
a client apparatus for remote-controlling said electronic measuring apparatuses; and
a dispatcher apparatus for setting a communication path that is used for data communication between said server apparatuses and said client apparatus, wherein:
said server apparatuses, said client apparatus, and said dispatcher apparatus are connected together via a network, and wherein said electronic measuring apparatus perform analog or digital signal processing to effect a predetermined measurement operation and output results of the predetermined measurement operation as digital data.

2. An automatic remote electronic instrument connecting system according to claim 1 wherein, said server apparatuses, said client apparatus, and said dispatcher apparatus send and receive data via an Ethernet.

3. An automatic remote electronic instrument connecting system comprising server apparatuses to which electronic measuring apparatuses are connected; a client apparatus for remote-controlling said electronic measuring apparatuses; and a dispatcher apparatus for setting a communication path that is used for data communication between said server apparatuses and said client apparatus, these apparatuses being connected together via a network, wherein:
said client apparatus includes a communicable-server-apparatus query section for requesting prior to data transmission to said server apparatuses, a list data on said server apparatuses and said electronic measuring apparatuses connected to said network, and wherein:
said dispatcher apparatus includes a communicable-server-apparatus query response section for returning said list data in response to the request from said communicable-server-apparatus query section, and wherein:
said electronic measuring apparatuses perform analog or digital signal processing to effect a predetermined measurement operation and output results of the predetermined measurement operation as digital data.

4. The automatic remote electronic instrument connecting system according to claim 3, wherein: said server apparatuses comprise a server apparatus information registration section for generating registered information containing contents of services which can be provided by an electronic measuring apparatus and measurement specifications when a power is applied to the electronic measuring apparatus, and for transmitting the registered information to said dispatcher apparatus; and said communicable-server-apparatus query response section generates according to said registered information said list data containing the server apparatuses with which said client apparatus requests to communicate.

5. An automatic remote electronic instrument connecting system according to claim 3 wherein said client apparatus comprises a data communication request section for requesting said communication path to be established before data transmission to said server apparatus, wherein:
said dispatcher apparatus includes a data communication request processing section for checking in response to the request for the establishment of said communication path sent from said data communication request section whether said electronic measuring apparatus is enabled to communicate and if so, establishing the communication path between said electronic measuring apparatus and said client apparatus, and wherein:
after said data communication request section has obtained the communication path established by said data communication request processing section, said client apparatus and said electronic measuring apparatus execute predetermined data communication via the communication path obtained.

6. An automatic remote electronic instrument connecting system according to claim 5 wherein said dispatcher apparatus includes a server apparatus information storage section for storing information on server apparatuses actually connected to said network, and wherein:
said data communication request processing section establishes the communication path when said server apparatuses with which said client apparatus desires to communicate is registered in said server apparatus information storage section.

7. An automatic remote electronic instrument connecting system according to claim 5 wherein said server apparatus includes a data communication request determining section for determining whether said selected electronic measuring apparatus is enabled to communicate, and wherein:
said data communication request processing section establishes the communication path when said data communication request determining section determines that said selected electronic measuring apparatus is enabled to communicate.

8. An automatic remote electronic instrument connecting system according to claim 3 wherein said client apparatus comprises an electronic-measuring-apparatus control section for remote-controlling said electronic measuring apparatuses by sending and receiving data to and from said electronic measuring apparatuses.

9. An automatic remote electronic instrument connecting method wherein a client apparatus, server apparatuses, and a dispatcher apparatus are connected together via a network, and wherein the server apparatuses and the client apparatus execute data communication via a communication path set by said dispatcher apparatus to allow said client apparatus to remote-control an electronic measuring apparatus connected to a selected said server apparatus, the method comprising:
using a data communication request section in the client apparatus to send a request for the establishment of said communication path to said dispatcher apparatus, before data transmission to said selected server apparatus;
using a data communication request processing section in said dispatcher apparatus to check in response to said establishment request sent from said client apparatus whether said electronic measuring apparatus is enabled to communicate and if so, establishing the communication path between said selected server apparatus and said client apparatus;
after said data communication request section has obtained said communication path established by said data communication request processing section, allowing said client apparatus and said electronic measuring apparatus connected to said selected server apparatus to execute data communication via the communication path obtained, wherein:
said electronic measuring apparatus performs analog or digital signal processing to effect a predetermined measurement operation and output results of the predetermined measurement operation as digital data.

10. The automatic remote electronic instrument connecting method according to claim 9, wherein:
the server apparatus information registration section of said server apparatus generates registered information containing contents of services which can be provided by an electronic measuring apparatus and measurement specifications when power is applied to the electronic measuring apparatus, transmitting the registered information to said dispatcher apparatus; and the communicable-server-apparatus query response section of said dispatcher apparatus generating according to the registered information said list data containing the server apparatus with which said client apparatus requests to communicate, and transmitting the list data to said client apparatus.

11. An automatic remote electronic instrument connecting method according to claim 9 wherein the method stores information on actually connected server apparatuses in a server apparatus information storage section in said dispatcher apparatus, and wherein:
said data communication request processing section establishes said communication path when a server apparatus of said server apparatuses with which said client apparatus desires to communicate is registered in said server apparatus information storage section.

12. An automatic remote electronic instrument connecting method according to claim 11 wherein said information stored in said server apparatus information storage section includes at least the names of said server apparatuses, wherein:
said establishment request sent from said data communication request section to said data communication request processing section includes the name of said server apparatuses for which said communication path is to be established, and wherein:
based on this name, said data communication request processing section checks whether the server apparatus is registered in said server apparatus information storage section.

13. An automatic remote electronic instrument connecting method according to claim 9 wherein a data communication request determining section in said selected server apparatus determines whether said electronic measuring apparatus is enabled to communicate, and wherein:
if said data communication request determining section determines that said electronic measuring apparatus is enabled to communicate, said data communication request processing section establishes said communication path.

14. An automatic remote electronic instrument connecting method according to claim 9 wherein the method uses an electronic-measuring-apparatus control section in said client apparatus to send and receive data to and from said electronic measuring apparatus in order to remote-control said electronic measuring apparatus.
